(19) United States
(12) Patent Application Publication
(10) Pub. No.: US 2016/0124633 A1
(43) Pub. Date: May 5, 2016

(54) ELECTRONIC APPARATUS AND INTERACTION METHOD FOR THE SAME

(71) Applicant: Samsung Electronics Co., Ltd., Suwon-si (KR)

(72) Inventors: Yun-kyung KIM, Suwon-si (KR); Min-kyoung YOON, Seoul (KR); Ji-yeon KWAK, Seoul (KR); Ji-hyun KIM, Seongnam-si (KR); Hyun-suk KIM, Seoul (KR)

(21) Appl. No.: 14/932,376

(22) Filed: Nov. 4, 2015

(30) Foreign Application Priority Data
Nov. 5, 2014 (KR) 10-2014-0152752

(51) Int. Cl. G06F 3/0488; G06F 3/0484; G06F 3/0482; G06F 1/16; G06F 3/041; G06F 3/0485

(52) U.S. Cl. CPC G06F 3/04883; G06F 3/0416; G06F 3/0485; G06F 3/0482; G06F 3/04886; G06F 1/163; G06F 3/04842

(57) ABSTRACT

An electronic apparatus is provided. The electronic apparatus includes a touch screen configured to display content and to sense a user input that is input to the touch screen, a bezel part housing the touch screen, a touch sensing unit configured to sense a user input that is input to the bezel part, and a control unit configured to select one character from a first set of characters based on a first user input when receiving the first user input starting at the bezel part and ending at the touch screen, and to select one character from a second set of characters based on a second user input when receiving the second user input from the touch screen.

### CROSS-REFERENCE TO RELATED APPLICATION(S)

This application claims the benefit under 35 U.S.C. §119(a) of a Korean patent application filed on Nov. 5, 2014 in the Korean Intellectual Property Office and assigned Serial number 10-2014-0152752, the entire disclosure of which is hereby incorporated by reference.

### TECHNICAL FIELD

The present disclosure relates to an electronic apparatus and a method for inputting characters in the electronic apparatus.

### BACKGROUND

Recently, an electronic apparatus has been implemented in a wearable device form distinguished from a smart phone form. As the wearable device is produced in a design form for weight reduction, simplification, etc., a size of the existing touch screen keeps decreasing, such that a user interaction method using a touch screen in a wearable device cannot but be extremely limited. To cope therewith, the interaction method using speech recognition, etc., has been used. However, the speech recognition may be sensitive to surrounding noise and therefore accuracy of the speech recognition may be reduced.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus and an interaction method for the same. In particular, an electronic apparatus such as a wearable device is produced in a small form to wear on a user's body. The present disclosure provides a method for allowing a user to conveniently operate a small wearable device.

In accordance with an aspect of the present disclosure, an electronic apparatus is provided. The electronic apparatus includes a touch screen configured to display contents and to sense a user input that is input to the touch screen, a bezel part housing the touch screen, a touch sensing unit configured to sense a user input that is input to the bezel part, and a control unit configured to select one character from a first set of characters based on a first user input when receiving the first user input starting at the bezel part and ending at the touch screen, and to select one character from a second set of characters based on a second user input when the touch screen receives the second user input.

The control unit may be configured to select the one character from the first set of characters depending on a length of the first user input when receiving the first user input.

The control unit may be configured to temporarily display the selected one character on the touch screen and to input the one character to the electronic apparatus when the first user input is released.

The control unit may be configured to determine the one character to be input to the electronic apparatus based on a position at which the first user input is sensed.

The bezel part may include a plurality of sides and the control unit may be configured to receive a third user input from one of the plurality of sides, and to select one character from a third set of characters based on the third user input.

The control unit may be configured to select one character from the second set of characters based on a direction of the second user input.

In accordance with another aspect of the present disclosure, an electronic apparatus is provided. The electronic apparatus includes a touch screen configured to display contents and to sense a user input that is input to the touch screen, a bezel part housing the touch screen, a touch sensing unit configured to sense the user input that is input to the bezel part, and a control unit configured to receive a first user input starting at the bezel part and ending at the touch screen, and to select one character from a first set of characters based on a position at which the first user input is sensed and a length of the first user input.

The control unit may be configured to receive a second user input from the touch screen toward the bezel part, and to select one character from a second set of characters based on a direction of the second user input.

In accordance with another aspect of the present disclosure, an electronic apparatus is provided. The electronic apparatus includes a touch screen configured to display a keyboard and to sense a user input that is input to the touch screen, a bezel part housing the touch screen, a strap connected to the bezel part, a touch sensing unit positioned at the strap and configured to sense a user input that is input to the strap, and a control unit configured to allow the touch sensing unit to receive a first user input, to enlarge some of the keyboard displayed on the touch screen, to display the enlarged keyboard based on the first user input, to receive a second user input selecting one character from the enlarged keyboard, and to input the selected character to the electronic apparatus based on the second user input.

The control unit may be configured to display a menu including a plurality of items on the touch screen, to allow the touch sensing unit to receive a third user input in a state in which the menu is displayed, and to scroll the item based on the third user input.

In accordance with another aspect of the present disclosure, an interaction method for an electronic apparatus is provided. The interaction method includes receiving a first user input starting at a bezel part and ending at a touch screen or receiving, by a touch screen, a second user input, and selecting one character from a first set of characters based on a first user input when the first user input is received and selecting one character from a second set of characters based on a second user input when the second user input is received.

When the first user input is received, the one character may be selected from the first set of characters depending on a length of the first user input.

The interaction method may further include temporarily displaying the selected one character on the touch screen, and when the first user input is released, inputting the selected one character to the electronic apparatus. In the selecting, the character to be input to the electronic apparatus may be determined based on a position at which the first user input is sensed.

The interaction method may further include receiving a third user input from one of a plurality of sides, and selecting one character from a third set of characters based on the third user input, wherein the bezel part includes the plurality of sides.

In the receiving of the second user input, one character may be selected from the second set of characters based on a direction of the second user input.

In accordance with another aspect of the present disclosure, an interaction method for an electronic apparatus is provided. The interaction method includes receiving a first user input starting from a bezel part and ending at a touch screen, and selecting one character from a first set of characters based on a position at which the first user input is sensed and a length of the first user input.

The interaction method may further include receiving a second user input moving from the touch screen toward the bezel, and selecting one character from a second set of characters based on a direction of the second user input.

In accordance with another aspect of the present disclosure, an interaction method for an electronic apparatus is provided. The interaction method includes receiving, by a touch sensing unit, a first user input, enlarging some of a virtual keyboard displayed on a touch screen based on the first user input, displaying the enlarged virtual keyboard, receiving a second user input selecting one character from the enlarged keyboard, and inputting the selected character to the electronic apparatus based on the second user input.

The interaction method may further include displaying a menu including a plurality of items on the touch screen, and receiving, by the touch sensing unit, a third user input in a state in which the menu is displayed and scrolling the menu item based on the third user input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are diagrams illustrating an electronic apparatus according to an embodiment of the present disclosure;

FIG. 2 is a block diagram of the electronic apparatus according to an embodiment of the present disclosure;

FIG. 3 is a diagram for describing a method for inputting characters to an electronic apparatus according to an embodiment of the present disclosure;

FIG. 4 is a diagram illustrating a process of inputting vowels using a touch screen according to a second user input according to an embodiment of the present disclosure;

FIG. 5 is a diagram illustrating that characters selected from a first set of characters are changed depending on a length of a first user input from a bezel part toward a touch screen according to an embodiment of the present disclosure;

FIG. 6 is a diagram illustrating an example of inputting characters to an electronic apparatus according to an embodiment of the present disclosure;

FIG. 7 is a diagram illustrating a process of inputting representative characters included in the first set of characters to the electronic apparatus according to an embodiment of the present disclosure;

FIG. 8 is a diagram illustrating a method for inputting lower characters corresponding to the representative characters according to an embodiment of the present disclosure;

FIG. 9 is a diagram illustrating a method for inputting vowels according to an embodiment of the present disclosure;

FIG. 10 is a diagram illustrating a method for inputting lower vowels according to an embodiment of the present disclosure;

FIG. 11 is a diagram illustrating a method for inputting Hangeul according to an embodiment of the present disclosure;

FIG. 12 is a diagram illustrating various methods for inputting Hangeul vowels according to an embodiment of the present disclosure;

FIG. 13 is a diagram illustrating an example of inputting Hangeul according to an embodiment of the present disclosure;

FIGS. 14A and 14B are diagrams illustrating an example of inputting the Hangeul vowels according to an embodiment of the present disclosure;

FIG. 15 is a diagram illustrating an example of inputting characters using a drag operation in a sensing unit included in a strap according to an embodiment of the present disclosure;

FIG. 16 is a diagram illustrating a method for scrolling an item of a menu screen according to a drag operation in a vertical direction from the sensing unit included in the strap according to an embodiment of the present disclosure;

FIG. 17 is a diagram illustrating an example of inputting words according to a drag operation in a horizontal and vertical direction from the sensing unit included in the strap and a touch input in the touch screen according to an embodiment of the present disclosure;

FIGS. 18 and 19 are diagrams illustrating a movement to a first portion and a final portion of a page displayed on the touch screen according to the drag operation toward the sensing unit in the touch screen according to an embodiment of the present disclosure;

FIG. 20 is a diagram illustrating a process of enlarging or reducing a font of content displayed on the touch screen according to the drag operation in the vertical direction from the sensing unit included in the strap in the state in which the touch screen is touched according to an embodiment of the present disclosure;

FIG. 21 is a diagram illustrating a process of changing a font displayed on the touch screen according to a drag operation in a horizontal direction from the sensing unit included in the strap in the state in which the touch screen is touched according to an embodiment of the present disclosure;

FIG. 22 is a diagram illustrating a process of changing font attributes of the contents displayed on the touch screen according to a tap operation in the sensing unit included in the strap in the state in which the touch screen is touched according to an embodiment of the present disclosure;

FIG. 23 is a diagram illustrating a method for inputting characters using the sensing unit installed at an end of the strap according to an embodiment of the present disclosure;

FIG. 24 is a flow chart illustrating a process when the bezel part and the touch screen receive a user input according to an embodiment of the present disclosure; and

FIGS. 25 and 26 are block diagrams schematically illustrating a configuration of the electronic apparatus according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Expressions such as “include” or “may include” which may be used in the present disclosure point out the presence of the disclosed corresponding functions, operations, components, or the like and do not limit at least one additional function, operation, component, or the like. Further, it will be further understood that the terms “comprises” or “have” used in the present disclosure, specify the presence of stated features, operations, components, parts mentioned in this specification, or a combination thereof, but do not preclude the presence or addition of one or more other features, numerals, operations, components, parts, or a combination thereof.

Expressions such as “or” in the present disclosure include any or all combinations of words listed together. For example, “A or B” may include A, B, or both A and B.

Expressions of “first”, “second”, “1st”, “2nd”, or the like in the present disclosure may modify various components in the present disclosure but do not limit the corresponding components. For example, the expressions do not limit order and/or importance, or the like of the corresponding components. The expressions may be used to differentiate one component from other components. For example, both of a first user device and a second user device are user devices and represent different user devices. For example, the ‘first’ component may be named the ‘second’ component, and vice versa, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present disclosure are used only in order to describe specific embodiments rather than limiting the present disclosure. Singular forms are intended to include plural forms unless the context clearly indicates otherwise.

Unless indicated otherwise, it is to be understood that all the terms used in the disclosure including technical and scientific terms has the same meaning as those that are understood by those who skilled in the art. Terms generally used and defined by a dictionary should be interpreted as having the same meanings as meanings within a context of the related art and should not be interpreted as having ideal or excessively formal meanings unless being clearly defined otherwise in the present disclosure.

In the present disclosure, a ‘module’ or a ‘unit’ performs at least one function or operation and may be implemented by hardware or software or a combination of the hardware and the software. Further, a plurality of ‘modules’ or a plurality of ‘units’ are integrated into at least one module except for the ‘module’ or ‘unit’ which needs to be implemented by specific hardware and thus may be implemented by at least one processor (not illustrated).

Hereinafter, an embodiment of the present disclosure will be described in detail with reference to the accompanying drawings. In describing an embodiment of the present disclosure with reference to the accompanying drawings, components that are the same as or correspond to each other will be denoted by the same reference numerals, and an overlapped description thereof will be omitted.

In describing a user interaction method in the present disclosure, a character input is described as an example, but the user interaction method is not limited to the character input. Therefore, all possible methods for interaction of a user with an electronic apparatus may be included.

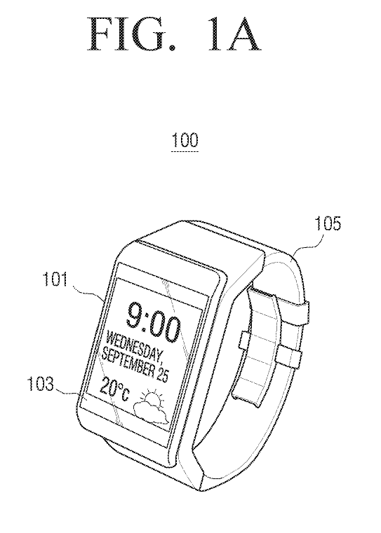

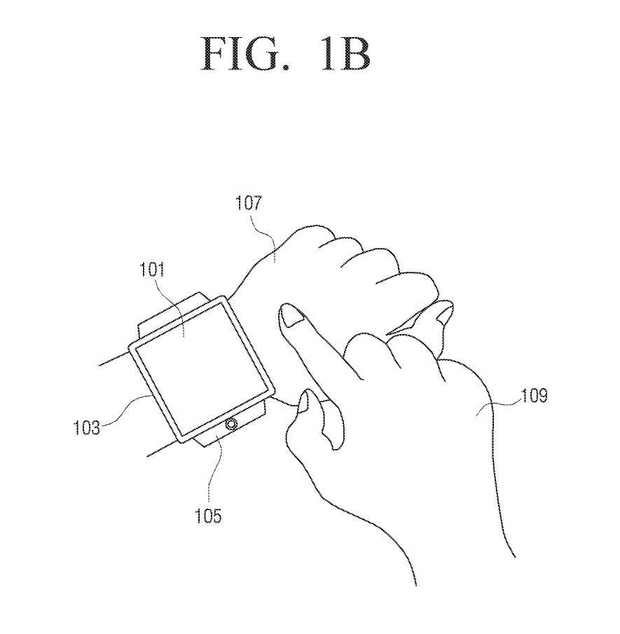

FIGS. 1A and 1B are diagrams illustrating an electronic apparatus according to an embodiment of the present disclosure. The electronic apparatus may be a wearable device. Referring to FIG. 1A, an electronic apparatus 100 may include a touch screen 101, a bezel part 103, and a strap 105. The bezel part 103 may enclose an outside of the touch screen 101, house the touch screen 101, and sense a user touch input. The bezel part 103 may include a touch sensing unit 103a and the electronic apparatus 100 may sense the user touch input through the touch sensing unit 103a of the bezel part 103. The touch screen 101 may include a touch detection sensor which may sense a touch and a display on which a graphic object may be displayed. The graphic object may include a user interface (UI) element which may interact with a user. The user may touch the UI element displayed on the touch screen 101 to control the electronic apparatus 100.

The strap 105 may be a band form and may fix the electronic apparatus 100 to a user's wrist. The strap 105 may include the touch sensing unit 103a and may sense the user touch input through the touch sensing unit 103a when the user touches the strap 105.

Referring to FIG. 1B, the electronic apparatus 100 is worn on a user's hand 107. The electronic apparatus 100 may include the touch screen 101, a bezel part 103 which may sense a touch, and the strap 105. The user may manipulate the electronic apparatus with the other hand 109.

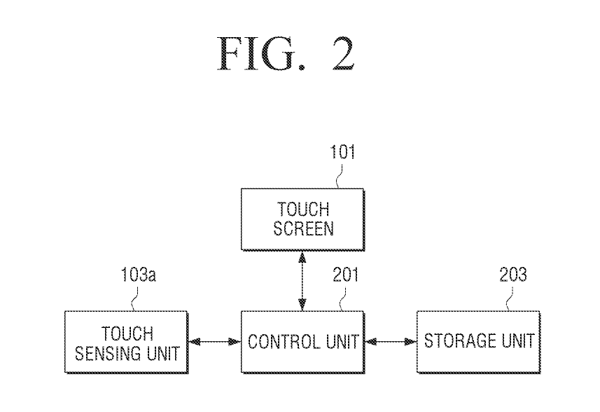

FIG. 2 is a block diagram of the electronic apparatus 100 according to an embodiment of the present disclosure. Referring to FIG. 2, the electronic apparatus 100 may include the touch screen 101, the touch sensing unit 103a, a control unit 201, and a storage unit 203.

The touch screen 101 may sense a touch and may be a form in which the touch sensing sensor and the display are combined. The touch screen 101 may sense a user input and display contents and the graphic object. The user input may be at least one of a touch, a drag, a tap, a flick, and a swipe. The graphic object may include a UI element.

The touch sensing unit 103a may be positioned at the bezel part 103 enclosing the touch screen 101, sense the user input, and output an electrical signal to the control unit 201 based on the user input. Further, the touch sensing unit 103a may be positioned at the strap 105.

The control unit 201 serves to process a general operation and data of the electronic apparatus 100. The control unit 201 may receive an electrical signal output from the touch sensing unit 103a and determine a position at which the user input is generated and a kind of user input based on the electrical signal.

When receiving a first user input moving from the bezel part 103 to the touch screen 101, the control unit 201 may select one character from a first set of characters and when receiving a second user input moving from the touch screen 101 to the bezel part 103, the control unit 201 may select one character from a second set of characters.

That is, when receiving the first user input starting from the bezel part 103 and ending at the touch screen 101, the control unit 201 may select one character from the first set of characters based on the first user input and when the touch screen 101 receives the second user input, the control unit 201 may select one character from the second set of characters based on the second user input.

The first user input may be to move to the touch screen 101 while the user brings his/her finger or a stylus pen into contact with the bezel part 103. That is, the first user input may be drag, flick, and swipe gestures. The first set of characters may be configured of consonants.

The second user input may be to move to the bezel part 103 while the user brings his/her finger or a stylus pen into contact with the touch screen 101. That is, the second user input may be drag, flick, and swipe gestures. The second set of characters may be configured of vowels.

The bezel part 103 is disposed outside the touch screen 101 and may include the touch sensing unit 103a.

When receiving the first user input, the control unit 201 may select one character from the first set of characters based on a moving length of a user's finger.

Further, the control unit 201 may control the touch screen 101 to temporarily display characters included in the first set of characters on the touch screen 101 based on the moving length and to display the characters temporarily displayed on the touch screen 101 on a position at which a cursor is displayed, when the user input is released. For example, when the first set of characters is configured of consonants, if the user's finger moves toward the touch screen 101 while the user touches the bezel part 103, the control unit 201 may display the ‘B’ on the touch screen 101. In this state, if the user's finger keeps on moving toward the touch screen 101, the control unit 201 may control the touch screen 101 to display ‘C’ on the touch screen 101.

The storage unit 203 stores commands and data processed in various applications which are performed and processed in the electronic apparatus 100 and may include at least one nonvolatile memory and volatile memory. The storage unit 203 may include at least one of a read only memory (ROM), a flash memory, a random access memory (RAM), an internal hard disk drive (HDD), an external hard disk, an external storage medium, etc. Further, the storage unit 203 may store an operating system of the electronic apparatus and programs and data associated with an operation of controlling the display of the touch screen 101.

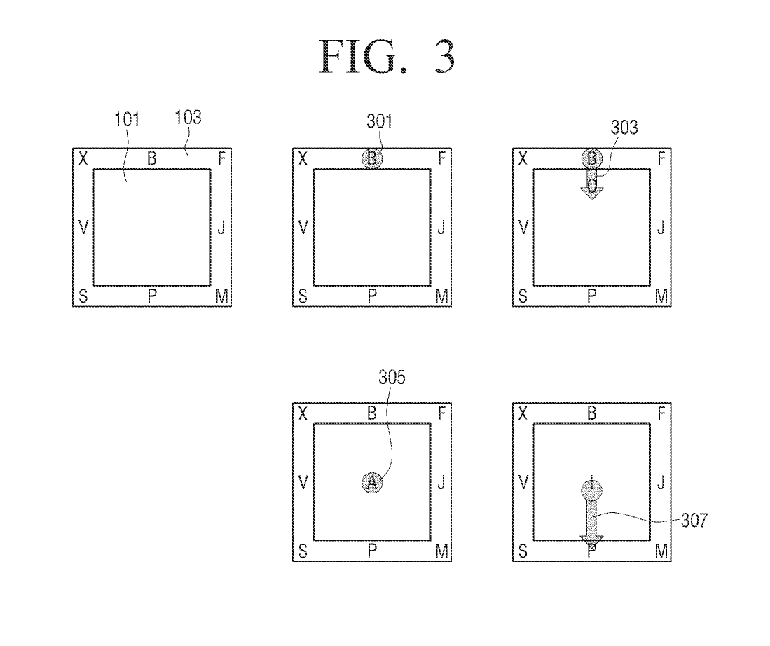

FIG. 3 is a diagram for describing a method for inputting characters to an electronic apparatus according to an embodiment of the present disclosure. FIG. 3 illustrates the touch screen 101 and the bezel part 103. The bezel part 103 is disposed outside the touch screen 101 and may include the touch sensing unit 103a. The bezel part 103 may generally be a square, but may be a triangle, a pentagon, a hexagon, and a circle. Further, the bezel part 103 may include a plurality of sides. For example, the bezel part may include four sides. Although an example in which the bezel part has four sides will be described below for convenience, even when the bezel part has a plurality of sides, the method according to the embodiment of the present disclosure may be applied.

The touch sensing unit 103a may sense the user input and may output the electrical signal to the control unit 201 based on the user input. The user input may be touch, tap, drag, swipe, and flick operations. When the user taps the bezel part 103, representative characters may be displayed on each side and each corner of the bezel part 103. Alternatively, the representative characters displayed on the bezel part 103 may be always displayed when a power supply of the electronic apparatus 100 is turned on, regardless of whether the user performs the tap operation. Alternatively, the representative characters displayed on the bezel part 103 may be automatically displayed at the time of driving a specific application requiring a character input.

The representative characters may be displayed on the bezel part 103 through a light emitting diode (LED) backlight. However, this is only an example, and therefore the representative characters may be displayed using a second touch screen different from the touch screen 101 as the bezel part 103. In this case, the bezel part 103 may be the second touch screen. Alternatively, the representative characters may be displayed using an outside portion of the touch screen 101. That is, when there is no bezel part 103, the representative characters may be displayed on the outside portion of the touch screen 101 and when there is the bezel part 103, the representative characters may be displayed on the outside portion of the touch screen 101.

Representative characters of consonants may correspond to each side and each corner of the bezel part 103. The representative characters may be some of the entire consonants. For example, the ‘B’ may be displayed on an upper side of the bezel part 103. The ‘P’ may be displayed on a lower side of the bezel part 103. The ‘V’ may be displayed on a left side of the bezel part 103. The ‘J’ may be displayed on a right side of the bezel part 103. The ‘F’ may be displayed on an upper right corner of the bezel part 103. The ‘X’ may be displayed on an upper left corner of the bezel part 103. The ‘M’ may be displayed on a lower right corner of the bezel part 103. The ‘S’ may be displayed on a lower left corner of the bezel part 103. The representative characters may be ‘B’, ‘F’, ‘J’, ‘M’, ‘P’, ‘S’, ‘V’, and ‘X’. The representative characters may be displayed on a corresponding position of the bezel part 103.

Each representative character may have at least one corresponding lower character. For example, the representative character ‘B’ may have lower characters ‘C’ and ‘D’. The representative character ‘F’ may have lower characters ‘G’ and ‘H’. The representative character ‘J’ may have lower characters ‘K’ and l′. The representative character ‘M’ may have a lower character ‘N’. The representative character ‘P’ may have lower characters ‘Q’ and ‘R’. The representative character ‘S’ may have a lower character ‘T’. The representative character ‘V’ may have a lower character ‘W’. The representative character ‘X’ may have lower characters ‘Y’ and ‘Z’.

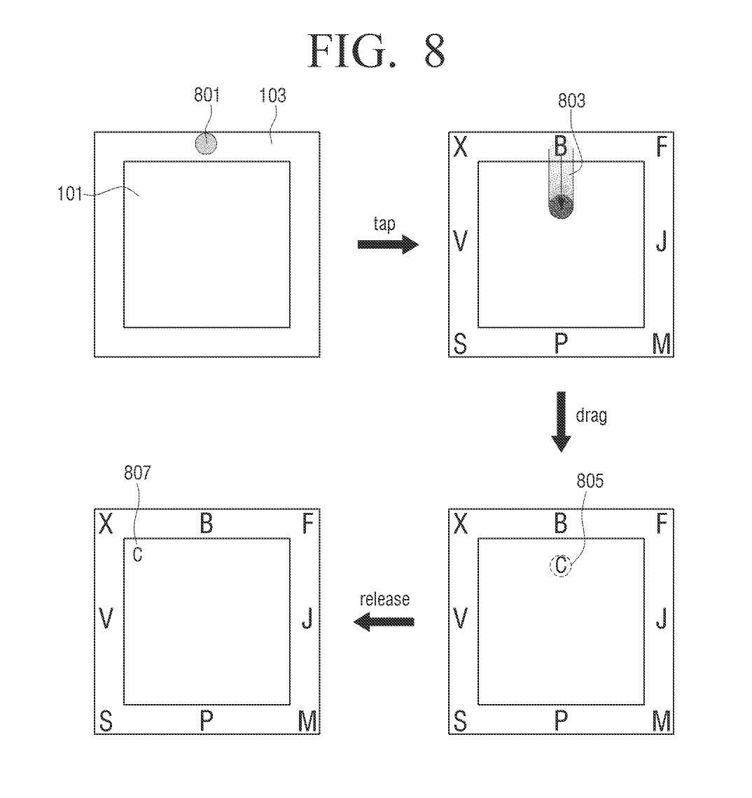

The representative characters corresponding to each side and each corner of the bezel part 103 and the lower characters corresponding to each representative character may be determined in advance by the electronic apparatus 100. Alternatively, they may be set by the user. A method for inputting lower characters will be described in detail with reference to FIG. 8.

When the user taps the bezel part 103, characters may be displayed on each side and each corner of the bezel part 103. If it is sensed that the user taps the bezel part 103, the control unit 201 may control the bezel part 103 to display characters at each side and each corner of the bezel part 103. In this state, when the user touches characters displayed on the bezel part 103, the control unit 201 may input the touched characters. Alternatively, when the user touches the characters displayed on the bezel part 103 and then releases the touch, the control unit 201 may input the touch released characters. The input characters may be displayed on the touch screen 101. A position displayed on the touch screen 101 may be a point at which the cursor is positioned. For example, when the user taps the bezel part 103, the control unit 201 controls the bezel part 103 to display representative characters ‘B’, ‘F’, ‘J’, ‘M’, ‘P’, ‘S’, ‘V’, and ‘X’ and when the user touches the representative character ‘B’ displayed on the bezel part 103 and then releases the touch, the control unit 201 may input the ‘B’.

The control unit 201 may receive the first user input moving from the bezel part 103 toward the touch screen 101 or receive the second user input moving from the touch screen 101 toward the bezel part 103. The first user input may be an operation of moving the user's finger toward the touch screen 101 and releasing the touch from the touch screen 101 while the user's finger touches the bezel part 103. The first user input may be the drag, flick, and swipe operations. The second user input may be an operation of moving the user's finger toward the bezel part 103 and releasing the touch from the bezel part 103 while the user's finger touches the touch screen 101. The second user input may be the drag, flick, and swipe operations.

When receiving the first user input starting from the bezel part 103 and ending at the touch screen 101, the control unit 201 may select one character from the first set of characters based on the first user input and when the touch screen 101 receives the second user input, the control unit 201 may select one character from the second set of characters based on the second user input.

The first set of characters may be a set of consonants. In the case of the English alphabet, the first set of characters may include ‘B’, ‘C’, ‘D’, ‘F’, ‘G’, ‘H’, ‘J’, ‘K’, ‘M’, ‘N’, ‘P’, ‘R’, ‘S’, ‘T’, ‘V’, ‘W’, ‘X’, ‘Y’, and ‘Z’. In the case of Hangeul, the first set of characters may include [symbol] [symbol] [symbol] [symbol] , and [symbol] .

The second set of characters may be a set of vowels. In the case of the English alphabet, the second set of characters may include ‘A’, ‘E’, ‘I’, ‘O’, and ‘U’. In the case of Hangeul, the second set of characters may include [symbol] , [symbol] and [symbol] .

If the user performs the drag operation toward the touch screen 101 in the state in which he/she touches the characters displayed on the bezel part 103 while the representative characters are displayed on the bezel part 103, the control unit 201 may control the touch screen 101 to display the lower characters of the characters displayed on the bezel part 103. In this case, the drag operation may be the first user input.

Further, when receiving the first user input, the control unit 201 may select one character from the first set of characters depending on a length of the first user input. That is, the control unit 201 may determine a length of the user's drag operation and may select characters corresponding to the length of the drag operation.

For example, if the user touches 301 the ‘B’ displayed on the bezel part 103 and then performs a drag operation 303 toward the touch screen 101, the control unit 201 may control the touch screen 101 to display the ‘C’ which is the lower character of the ‘B’ on the touch screen 101. In this state, when the user releases a touch, the control unit 201 may determine that the ‘C’ is selected. If the user continuously performs the drag operation 303 toward the touch screen 101 while he/she keeps a touch in the state in which the ‘C’ is displayed on the touch screen 101, the control unit 201 may control the touch screen 101 to display the ‘D’ on the touch screen 101. In this state, when the user releases a touch, the control unit 201 may determine that the ‘D’ is selected.

If the touch is sensed in the state in which the representative characters are displayed on the bezel part 103 and the user input continuously performing the drag operation toward the touch screen 101 is sensed, the control unit 201 may control the touch screen 101 to display the lower characters of the representative characters on the touch screen 101. Here, the drag operation may be replaced by the swipe or flick operation.

That is, if the user touches the bezel part 103 and performs the drag operation toward the touch screen 101, the control unit 201 may control the touch screen 101 to alternately display the ‘C’ and the ‘D’ on the touch screen 101 depending on a drag length. When the user releases a touch, the control unit 201 may select the characters displayed on the touch screen 101 and input the selected characters to the electronic apparatus 100.

When the touch screen 101 receives the second user input, the control unit 201 may select one character from the second set of characters. The second user input may be the drag operation from the touch screen 101 toward the bezel part 103. Alternatively, the second user input may be the flick operation from the touch screen 101 toward the bezel part 103. Alternatively, the second user input may be the swipe operation from the touch screen 101 toward the bezel part 103.

The second set of characters may be configured of vowels. In the case of the English alphabet, the second set of characters may include ‘A’, ‘E’, ‘I’, ‘O’, and ‘U’. When the touch screen 101 senses a touch, the control unit 201 may control the touch screen 101 to display one of the second set of characters on the touch screen 101. If the second user input is sensed in the state in which the characters are displayed on the touch screen 101, the control unit 201 may control the touch screen 101 to sequentially display the characters included in the second set of characters on the touch screen 101 depending on a direction of a second user input. That is, the control unit 201 may select one character from the second set of characters based on a direction of the second user input and input the selected character to the electronic apparatus 100. The direction of the second user input may be a direction toward up, down, left, and right sides based on the touch screen 110 and each corner of the bezel part 103. The control unit 201 may select different characters from the characters included in the second set of characters depending on the direction of the second user input.

Further, if the touch release is sensed, the control unit 201 may determine characters to select characters displayed on the touch screen 101. For example, if the user touches 305 the touch screen 101, the control unit 201 may control the touch screen 101 to display the ‘A’ of the characters included in the second set of characters on the touch screen 101. If the touch release is sensed in the state in which the ‘A’ is displayed on the touch screen 101, the control unit 201 may determine that the ‘A’ is selected. Further, if the drag operations in all directions are sensed in the state in which the ‘A’ is displayed on the touch screen 101, the control unit 201 may control the touch screen 101 to display the ‘E’, the ‘I’, the ‘O’, or the ‘U’ on the touch screen 101 according to the drag operation direction. If the user touches the touch screen 101, the control unit 201 may control the touch screen 101 to display the ‘A’ on the touch screen 101. In this state, if the user performs a drag operation 307 downwardly, the control unit 201 may control the touch screen 101 to display the ‘I’. In this case, the drag operation from the touch screen 101 toward the bezel part 103 may be performed and the drag operation may also extend up to the bezel part 103. That is, the drag operation may start from the touch screen 101 and end at the bezel part 103.

The control unit 201 may determine characters to be input to the electronic apparatus 100 based on a position at which the first user input is sensed. The bezel part 103 may have four sides. Here, the corresponding representative characters may be present at each of the four sides. The first user input may be sensed at four sides and corners and different characters may be input depending on the sensed positions.

For example, the ‘B’ may be displayed on the upper side of the bezel part 103. The ‘B’ may have the ‘C’ and the ‘D’ as the lower characters. If the user touches or releases the ‘B’ displayed on the upper side of the bezel part 103, the control unit 201 may input the ‘B’ to the electronic apparatus. If the user touches the ‘B’ displayed on the upper side of the bezel part 103 and performs the drag operation toward the touch screen 101, the control unit 201 may select the ‘C’ or the ‘D’ depending on the length of the drag operation and input the selected character to the electronic apparatus 100.

The ‘F’ may be displayed on the right upper side of the bezel part 103. The ‘F’ may have the ‘G’ and the ‘K’ as the lower characters. If the user touches the ‘F’ displayed on the right upper side of the bezel part 103 and then releases the touch, the control unit 201 may input the ‘F’ to the electronic apparatus 100. If the user touches the ‘F’ displayed on the right upper side of the bezel part 103 and performs the drag operation toward the touch screen 101, the control unit 201 may select the ‘G’ or the ‘K’ depending on the length of the drag operation and input the selected character to the electronic apparatus 100.

The ‘J’ may be displayed on the right side of the bezel part 103. The ‘J’ may have the ‘K’ and the ‘L’ as the lower characters. If the user touches the ‘K’ displayed on the right side of the bezel part 103 and then releases the touch, the control unit 201 may input the ‘K’ to the electronic apparatus 100. If the user touches the ‘K’ displayed on the right side of the bezel part 103 and performs the drag operation toward the touch screen 101, the control unit 201 may select the ‘K’ or the ‘L’ depending on the length of the drag operation and input the selected character to the electronic apparatus 100.

The ‘M’ may be displayed on the right lower side of the bezel part 103. The ‘M’ may have ‘N’ and ‘Q’ as the lower characters. If the user touches the ‘M’ displayed on the right lower side of the bezel part 103 and then releases the touch, the control unit 201 may input the ‘M’ to the electronic apparatus 100. If the user touches the ‘M’ displayed on the right lower side of the bezel part 103 and performs the drag operation toward the touch screen 101, the control unit 201 may select the ‘N’ and the ‘K’ depending on the length of the drag operation and input the selected characters to the electronic apparatus 100.

The selected character may be temporarily displayed on the touch screen 101 and when the first user input is released, the control unit 201 may input the selected character to the electronic apparatus. If the user touches the bezel part 103 and performs the drag operation toward the touch screen 101, the control unit 201 may control the touch screen 101 to temporarily display the characters on the touch screen 101 depending on the length of the drag operation. In this state, if the user releases the drag operation, the control unit 201 may temporarily input the displayed characters to the electronic apparatus 100.

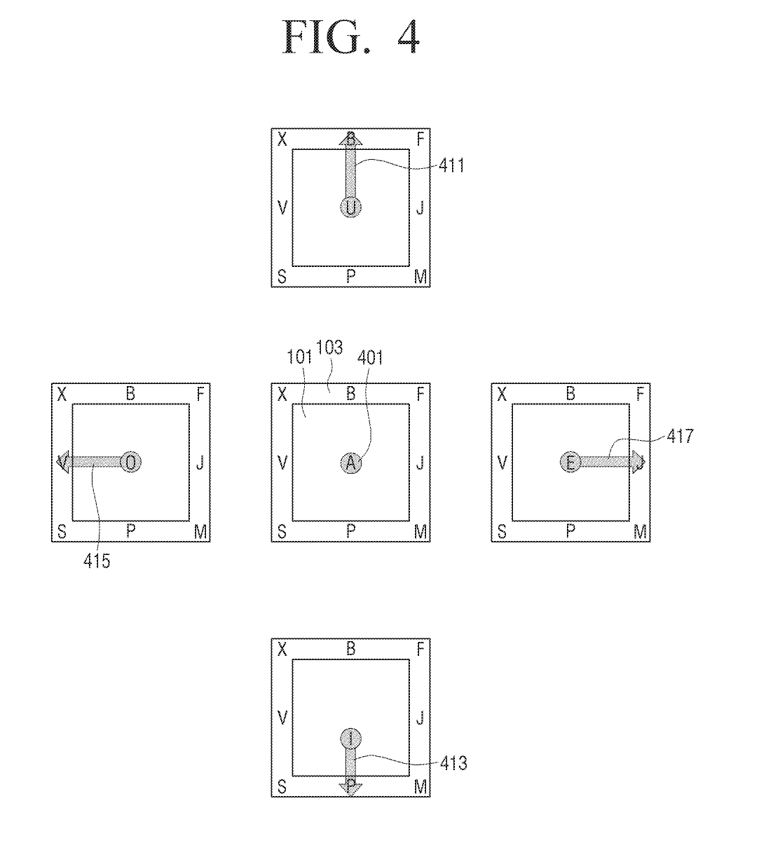

FIG. 4 is a diagram illustrating a process of inputting vowels using the touch screen 101 according to a second user input according to an embodiment of the present disclosure. The second user input may be one of the drag, flick, and swipe operations. FIG. 4 illustrates representative vowels and the direction of the second user input which are displayed on the touch screen 101. When the touch screen 101 receives the second user input, the control unit 201 may select one character from the second set of characters based on the direction of the second user input.

If the user touches 305 the touch screen 101, the control unit 201 may control the touch screen 101 to display one of the characters included in the second set of characters on the touch screen 101. The second set of characters may be a set of vowels. The characters displayed on the touch screen 101 may be representative vowels among the vowels. The representative vowels may be displayed around a point at which the touch is sensed.

In this state, if the user performs the drag operation toward the bezel part 103, the control unit 201 may control the touch screen 101 to display different characters from the characters displayed on the current touch screen 101 among the characters included in the second set of characters on the touch screen 101 depending on the drag direction. The drag direction may be all directions based on the point at which the touch is sensed.

For example, if the user touches 401 the touch screen 101, the control unit 201 may control the touch screen 101 to display the ‘A’ which is one of the characters included in the second set of characters on the position at which the touch is sensed or a central portion of the touch screen 101. The ‘A’ may be a representative vowel. If the user performs a drag operation 411 toward the upper bezel part 103 in the state in which the ‘A’ is displayed on the touch screen 101, the control unit 201 may control the touch screen 101 to display the ‘U’ on the touch screen 101.

If the user performs a drag operation 415 toward the left bezel part 103 in the state in which the ‘A’ is displayed on the touch screen, the control unit 201 may control the touch screen 101 to display the ‘O’ on the touch screen 101.

If the user performs a drag operation 417 toward the right bezel part 103 in the state in which the ‘A’ is displayed on the touch screen 101, the control unit 201 may control the touch screen 101 to display the ‘E’ on the touch screen 101.

If the user performs a drag operation 413 toward the lower bezel part 103 in the state in which the ‘A’ is displayed on the touch screen 101, the control unit 201 may control the touch screen 101 to display the ‘I’ on the touch screen 101.

If the touch release is sensed after the drag operation, the control unit 201 may determine characters to select characters displayed on the touch screen 101.

For example, if the ‘A’ is displayed on the touch screen 101 as the user touches the touch screen 101 and the user performs the drag operation toward the upper bezel part 103 in this state, the control unit 201 may control the touch screen 101 to display the ‘U’ on the touch screen 101 and if the user releases the touch, the control unit 201 may determine that the ‘U’ is selected.

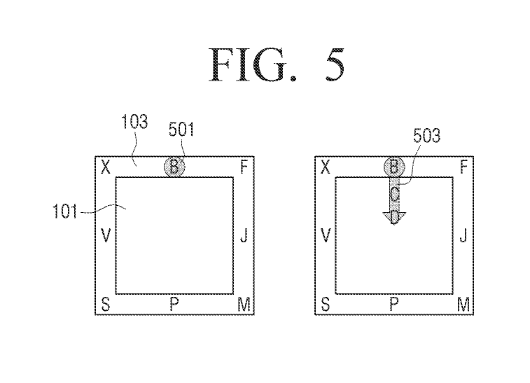

FIG. 5 is a diagram illustrating that the characters selected from the first set of characters are changed depending on the length of the first user input from the bezel part 103 toward the touch screen 101 according to an embodiment of the present disclosure. FIG. 5 illustrates that as the user touches 501 one side of the bezel part 103 and then performs a drag operation 503 toward the touch screen 101, the characters displayed on the touch screen 101 are changed to the ‘B’, the ‘C’, and the ‘D’.

For example, if the user touches 501 an upper portion of the bezel part 103, the control unit 201 may control the bezel part 103 to display the representative consonant ‘B’ on the upper bezel part 103. The representative consonant may be a representative character. In this state, if the user performs a drag operation 503 toward the touch screen 101, the control unit 201 may control the touch screen 101 to display the ‘C’ on the touch screen 101. In this state, if the user continuously performs the drag operation 503 toward the touch screen 101, the control unit 201 may control the touch screen 101 to display the ‘D’ on the touch screen 101.

When receiving the first user input, the control unit 201 may select one character from the first set of characters based on the moving length of the first user input. That is, if it is sensed that the user touches the bezel part 103, the control unit 201 may determine the position at which the touch is sensed and display the corresponding character on the bezel part 103. In this case, the characters displayed on the touch screen 101 may be the representative characters. The representative characters may be included in the first set of characters. The first user input may be the drag operation.

The control unit 201 may determine the moving length of the drag operation and may control the touch screen 101 to display the ‘C’ on the touch screen 101 when the moving length of the drag operation is smaller than a predetermined value and control the touch screen 101 to display the ‘D’ on the touch screen 101 when the length of the drag operation is larger than the predetermined value. In this case, positions at which the ‘C’ and the ‘D’ are displayed may be determined depending on the length of the drag operation. When the touch release is sensed after the drag operation, the control unit 201 may select the characters displayed on the touch screen 101 and input the selected characters to the electronic apparatus 100.

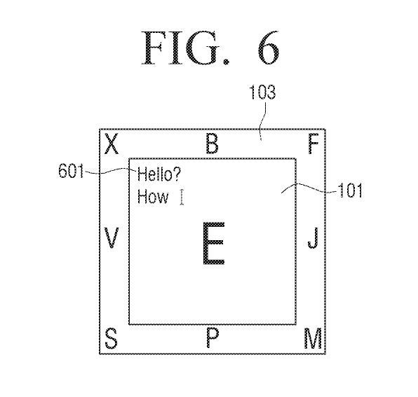

FIG. 6 is a diagram illustrating an example of inputting characters in the electronic apparatus 100 according to an embodiment of the present disclosure. FIG. 6 illustrates the touch screen 101 and the bezel part 103. The representative characters ‘B’, ‘F’, ‘J’, ‘M’, ‘P’, ‘S’, ‘V’, and ‘X’ included in the first set of characters may be displayed on the bezel part 103. An input character 601 and a cursor are display in a left upper area of the touch screen 101. That is, a character input window may be displayed on the touch screen 101. The character ‘E’ input to the electronic apparatus is displayed in a central area of the touch screen 101. The corresponding character may be displayed on the touch screen 101 according to the drag operation of the user and if the user releases the touch after the drag operation, the character ‘E’ displayed on the touch screen 101 may be selected, which may be then input to the electronic apparatus 100.

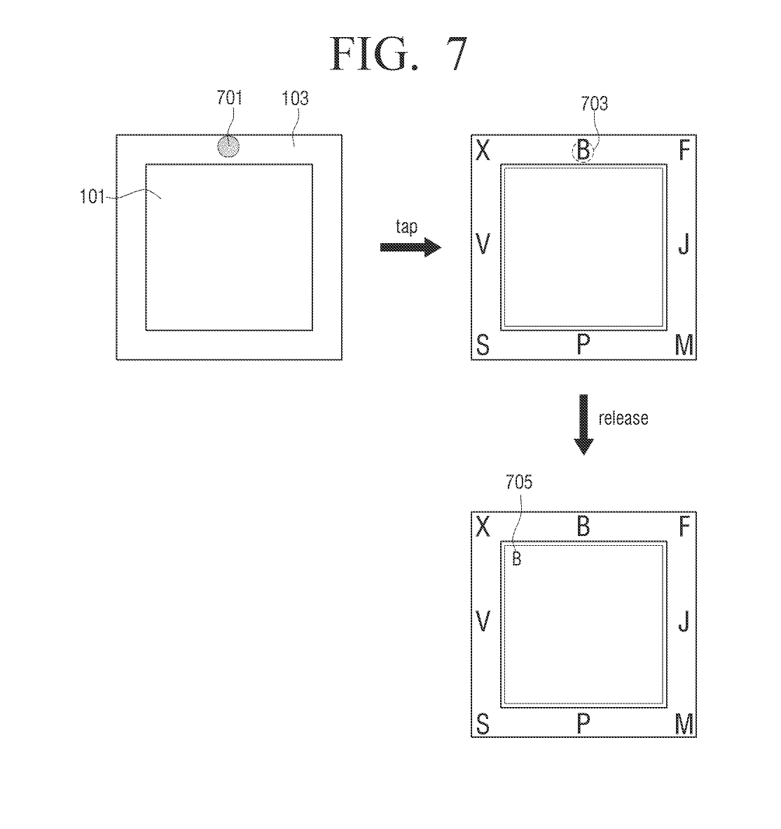

FIG. 7 is a diagram illustrating a process of inputting the representative characters included in the first set of characters to the electronic apparatus according to an embodiment of the present disclosure. The first set of characters may be a set of consonants. The representative characters may be representative consonants. FIG. 7 illustrates the touch screen 101 and the bezel part 103. When the user taps the bezel part 103, representative characters may be displayed on each side and each corner of the bezel part 103. Alternatively, the representative characters displayed on the bezel part 103 may be always displayed when a power supply of the electronic apparatus 100 is turned on, regardless of whether the user performs the tap operation. Alternatively, the representative characters displayed on the bezel part 103 may be automatically displayed at the time of driving a specific application requiring a character input. For example, when a character message application requiring the character input is driven, the representative characters may be automatically displayed on the bezel part 103.

The representative characters displayed on the bezel part 103 may be displayed on the bezel part 103 though an LED backlight. Alternatively, the representative characters may be displayed on the bezel part 103 using the second touch screen 101 different from the touch screen 101. In this case, the bezel part 103 may be the second touch screen. Alternatively, the representative characters may be displayed using an outside portion of the touch screen 101. In this case, the bezel part 103 may be the outside portion of the touch screen.

Representative characters of consonants may be displayed on each side and each corner of the bezel part 103. That is, the representative consonants may be displayed. For example, the ‘B’ may be displayed on the upper side of the bezel part 103. The ‘P’ may be displayed on the lower side of the bezel part 103. The ‘V’ may be displayed on the left side of the bezel part 103. The ‘J’ may be displayed on the right side of the bezel part 103. The ‘F’ may be displayed on the upper right corner of the bezel part 103. The ‘X’ may be displayed on the upper left corner of the bezel part 103. The ‘M’ may be displayed on the lower right corner of the bezel part 103. The ‘S’ may be displayed on the lower left corner of the bezel part 103. The representative characters may be ‘B’, ‘F’, ‘J’, ‘M’, ‘P’, ‘S’, ‘V’, and ‘X’. Each representative character may have at least one corresponding lower character. For example, the representative character ‘B’ may have the lower characters ‘C’ and ‘D’. The representative character ‘F’ may have the lower characters ‘G’ and ‘H’. The representative character ‘J’ may have the lower characters ‘K’ and ‘L’. The representative character ‘M’ may have the lower character ‘N’. The representative character ‘P’ may have the lower characters ‘Q’ and ‘R’. The representative character ‘S’ may have the lower character ‘T’. The representative character ‘V’ may have the lower character ‘W’. The representative character ‘X’ may have the lower characters ‘Y’ and ‘Z’.

The representative characters corresponding to each side and each corner of the bezel part 103 and the lower characters corresponding to each representative character may be determined in advance by the electronic apparatus 100. Alternatively, the user may set the representative characters and the lower characters. A method for inputting lower characters will be described in detail with reference to FIG. 8.

If it is sensed that the user taps 701 the bezel part 103, the control unit 201 may control the bezel part 103 to display characters at each side and each corner of the bezel part 103. In this state, when the user touches characters displayed on the bezel part 103, the control unit 201 may input the touched characters. Alternatively, when the user touches the characters displayed on the bezel part 103 and then releases the touch, the control unit 103 may input the touch released characters. The input characters may be displayed on the touch screen 101. The position displayed on the touch screen 101 may be a point at which the cursor is positioned.

For example, if the user taps 703 the bezel part 103, the control unit 201 may display the representative characters ‘B’, ‘F’, ‘J’, ‘M’, ‘P’, ‘S’, ‘V’, and ‘X’ on the bezel part 103 and if the user touches the representative character ‘B’ displayed on the bezel part 103 and then releases the touch, the ‘B’ may be input to the electronic apparatus and the ‘B’ may be displayed on the touch screens 101 and 705.

FIG. 8 is a diagram illustrating a method for inputting lower characters corresponding to the representative characters according to an embodiment of the present disclosure. FIG. 8 illustrates the touch screen 101 and the bezel part 103. The representative characters displayed on the bezel part 103 may have at least one of the corresponding lower characters.

If the user taps 801 the bezel part 103, the control unit 201 may control the bezel part 103 to display the representative characters on the bezel part 103. If the user touches the representative characters displayed on the bezel part 103 and performs a drag operation 803 toward the touch screen 101, the control unit 201 may control the touch screen 101 to display a lower character 805 corresponding to the representative character on the touch screen 101 and if the user releases the touch, the control unit 201 may input 807 the touch released character to the electronic apparatus 100. Here, the drag operation may be an operation of moving the user's finger while the user's finger keeps the touch. Further, the stylus pen may also perform the drag operation. The drag operation may be the first user input. Further, the drag operation may be replaced by the swipe or flick operation.

The representative character may have at least one lower character. When there are at least two lower characters, the control unit 201 may control the touch screen 101 to alternately display a first lower character and a second lower character on the touch screen 101 depending on the drag length. For example, when the lower character of the representative character ‘B’ is the ‘C’ and the ‘D’, the control unit 201 may control the touch screen 101 to alternately display the ‘C’ and the ‘D’ on the touch screen 101 depending on the drag length. As the user performs the drag operation, the control unit 201 may control the touch screen 101 to display the ‘C’ on the touch screen 101 and if the drag length exceeds a threshold value, the control unit 201 may control the touch screen 101 to display the ‘D’ on the touch screen 101. If the user releases the touch during the drag operation, the control unit 201 may control the touch screen 101 to input the lower character corresponding to the release point and to display the input lower character on the left upper of the touch screen 101 or the position at which the cursor is present. For example, if the user releases the drag operation in the state in which the ‘C’ is displayed, the control unit 201 may input the ‘C’. If the user releases the drag operation in the state in which the ‘D’ is displayed, the control unit 201 may input the ‘D’.

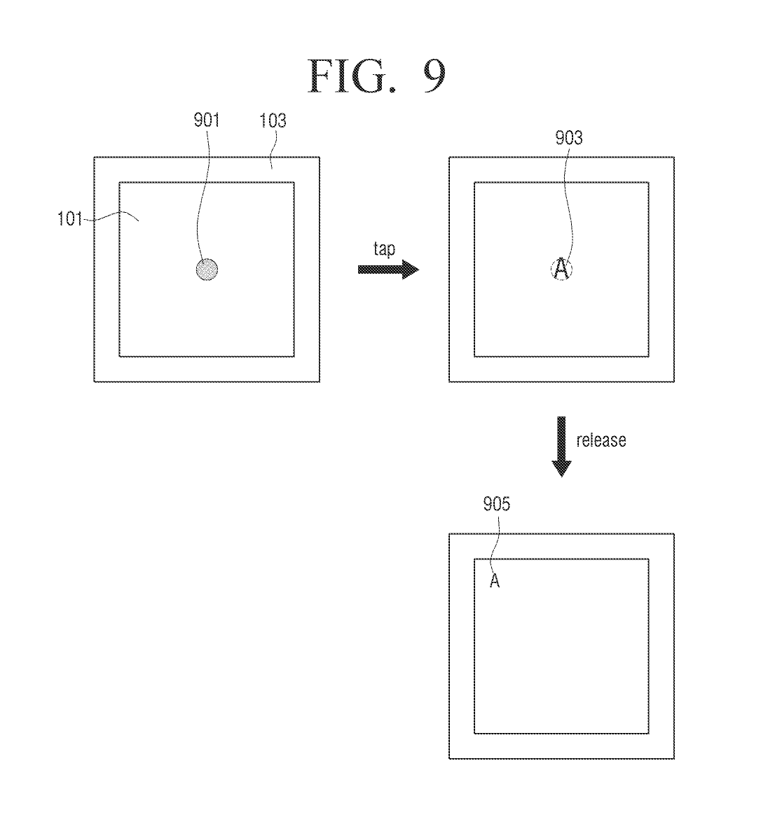

FIG. 9 is a diagram illustrating a method for inputting vowels according to an embodiment of the present disclosure. FIG. 9 illustrates the touch screen 101 and the bezel part 103. If the user taps 901 the touch screen 101, the control unit 201 may control the touch screen 101 to display a representative vowel 903 on the touch screen 101. The representative vowel 903 may be displayed on the central portion of the touch screen 101. If the user touches the representative vowel 903 displayed on the central portion of the touch screen 101 and then releases the touch, the control unit 201 may input the representative vowel displayed on the central portion of the touch screen to the electronic apparatus 100. The input representative vowel may be displayed on the left upper 905 of the touch screen 101 or the position at which the cursor is present.

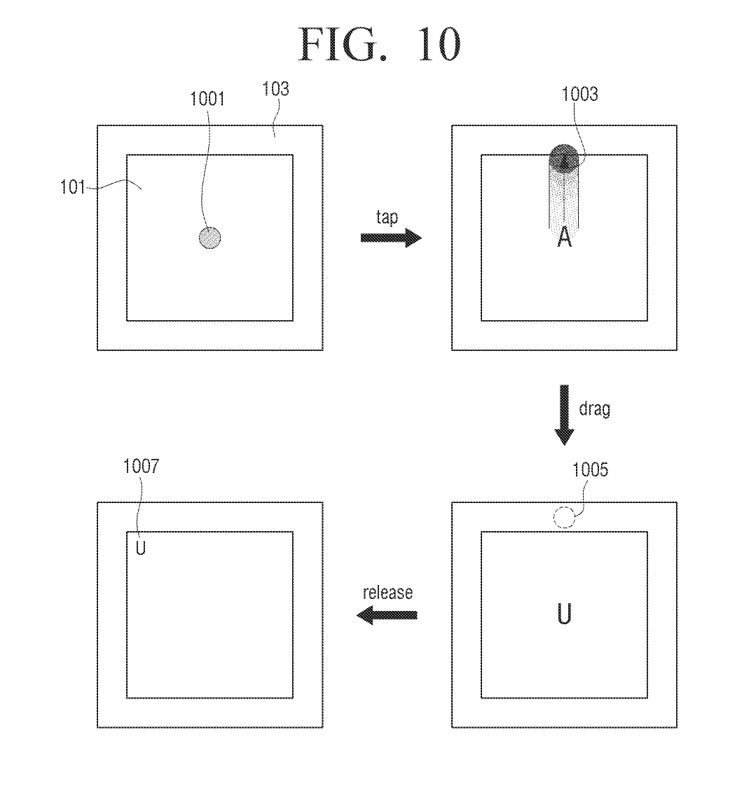

FIG. 10 is a diagram illustrating a method for inputting lower vowels according to an embodiment of the present disclosure. FIG. 10 illustrates the touch screen 101 and the bezel part 103. If the user taps 1001 the touch screen 101, the control unit 201 may control the touch screen 101 to display a representative vowel on the touch screen 101. In this state, if the user performs the drag operation 1003 from the touch screen 101 toward the bezel part 103, the control unit 201 may control the touch screen 101 to display a lower vowel on the touch screen 101. Here, the drag operation 1003 may be an operation of moving the user's finger while the user's finger keeps the touch. The finger may be replaced by the stylus pen. Further, the drag operation 1003 may be replaced by the swipe or flick operation. If the user releases 1005 the drag, the control unit 201 may input a drag released lower vowel to the electronic apparatus 100. In this case, the input lower vowel may be different depending on the drag direction.

The control unit 201 may select one character from the second set of characters based on the direction of the second user input. The second user input may be the drag operation.

For example, if the user performs the drag operation 1003 upwardly, the control unit 201 may control the touch screen 101 to display the lower vowel ‘U’ on the touch screen 101. In this state, if the user releases 1005 the drag operation, the control unit 201 may input the ‘U’ displayed on the central portion of the touch screen 101. The input lower vowel ‘U’ 1007 may be displayed on a left upper of the touch screen 101 or the position at which the cursor is present.

If the user performs the drag operation rightward, the control unit 201 may input the lower vowel ‘E’. If the user performs the drag operation downwardly, the control unit 201 may input the lower vowel ‘I’. If the user performs the drag operation leftward, the control unit 201 may input the lower vowel ‘O’.

When the drag operation starting from the touch screen 101 and ending at the bezel part 103 is performed, the control unit 201 may control the touch screen 101 to display the lower vowel corresponding to the drag direction. Alternatively, when the drag operation is sensed only by the touch screen 101, the control unit 201 may control the touch screen 101 to display the lower vowel corresponding to the drag direction.

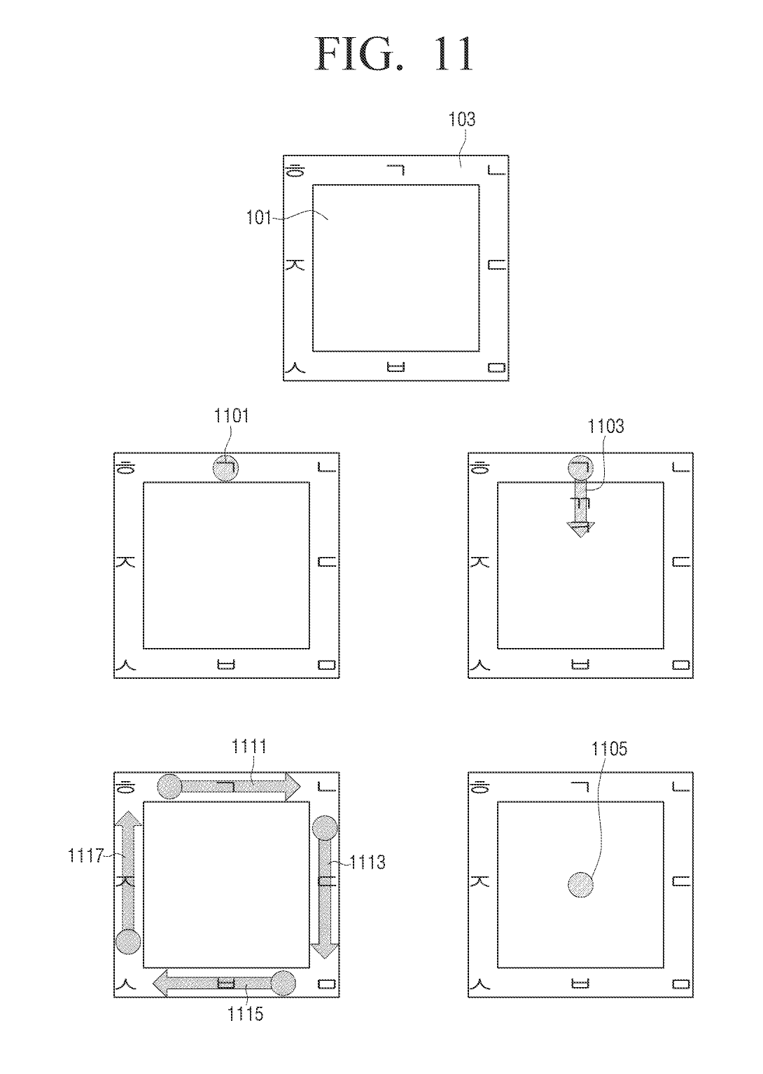

FIG. 11 is a diagram illustrating a method for inputting Hangeul according to an embodiment of the present disclosure. FIG. 11 illustrates the touch screen 101 and the bezel part 103. Representative Hangeul consonants may be displayed on the bezel part 103. The representative Hangeul consonants may be [symbol] , [symbol] [symbol] , and [symbol] . For example, the Hangeul consonant [symbol] may be displayed on the upper side of the bezel part 103. The Hangeul consonant [symbol] may be displayed on the lower side of the bezel part 103. The Hangeul consonant [symbol] may be displayed on the left side of the bezel part 103. The Hangeul consonant [symbol] may be displayed on the right side of the bezel part 103. The Hangeul consonant [symbol] may be displayed on the upper right corner of the bezel part 103. The Hangeul consonant [symbol] may be displayed on the upper left corner of the bezel part 103. The Hangeul consonant [symbol] may be displayed on the lower right corner of the bezel part 103. The Hangeul consonant [symbol] may be displayed on the lower left corner of the bezel part 103.

When receiving the first user input starting from the bezel part 103 and ending at the touch screen 101, the control unit 201 may select one character from the first set of characters based on the first user input. The first user input may be the drag operation.

If the user taps the bezel part 103, the control unit 201 may control the bezel part 103 to display the representative consonants on the bezel part 103. In this state, if the user touches 1101 the representative consonants displayed on the bezel part 103 and releases the touch, the control unit 201 may input the touch released representative consonants. Further, if the user touches 1101 the representative consonants displayed on the bezel part and performs a drag operation 1103 toward the touch screen 101, the control unit 201 may control the touch screen 101 to display a lower consonant on the touch screen 101. In this case, the control unit 201 may control the touch screen 101 to alternately display the lower consonants depending on the drag length and if the drag is released, the control unit 201 may input the lower consonant corresponding to the released position. Here, the drag operation may be an operation of moving the user's finger while the user's finger keeps the touch. The finger may be replaced by the stylus pen. The drag operation may be replaced by the swipe or flick operation.

The bezel part 103 may include four sides. The control unit 201 may allow one of the four sides to receive a third user input and select one character from a third set of characters based on the third user input. The third user input may be the drag operation. The third set of characters may be some of the Hangeul vowels. For example, the third set of characters may be [symbol] and [symbol] .

If the user performs the drag operation at the bezel part 103, the control unit 201 may input the Hangeul vowel [symbol] or [symbol] depending on drag directions 1111, 1113, 1115, and 1117. Alternatively, if the user performs the drag operation 1117 at the right bezel part 103, the control unit 201 may input the [symbol] . Alternatively, if the user performs the drag operation 1111 at the upper bezel part 103, the control unit 201 may input the [symbol] . Alternatively, if the user performs the drag operation 1113 at the left bezel part 103, the control unit 201 may input the [symbol] . Alternatively, if the user performs the drag operation 1115 at the lower bezel part 103, the control unit 201 may input the [symbol] .

Further, if the user taps 1105 the touch screen 101 and performs the drag operation at the bezel part 103 within a predetermined time, the control unit 201 may input [symbol] or [symbol] depending on the drag direction.

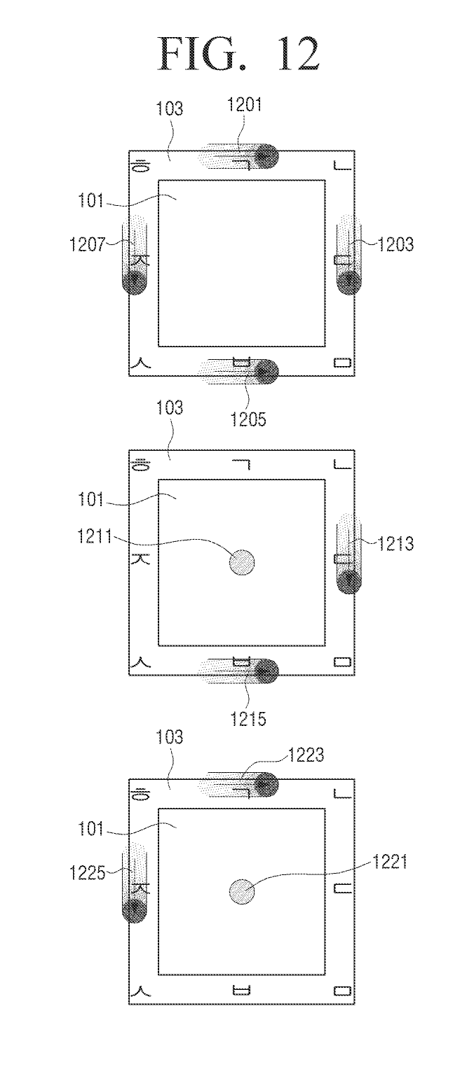

FIG. 12 is a diagram illustrating various methods for inputting Hangeul vowels according to an embodiment of the present disclosure. FIG. 12 illustrates the touch screen 101 and the bezel part 103. If the user performs the drag operation at the bezel part 103, the control unit 201 may input the Hangeul vowel [symbol] or [symbol] depending on drag directions 1201, 1203, 1205, and 1207. For example, if the user performs the drag operation 1201 in a horizontal direction from the upper bezel part 103, the control unit 201 may input the [symbol] . If the user performs the drag operation 1205 in a horizontal direction from the lower bezel part 103, the control unit 201 may input the [symbol] .

If the user touches or taps 1211 the touch screen 101 and continuously performs the drag operation at the bezel part 103 within a predetermined time, the control unit 201 may input the [symbol] or the [symbol] depending on drag directions 1213 and 1215. For example, if the user touches the touch screen 101 and performs a drag operation 1213 in a vertical direction from the right bezel part 103 within 1 to 2 seconds, the control unit 201 may input the [symbol] . If the user touches the touch screen 101 and performs a drag operation in a left or right direction from the lower bezel part 103 within 1 to 2 seconds, the control unit 201 may input the [symbol] .

If the user performs the drag operation 1223 or 1225 in a horizontal direction or a vertical direction from the bezel part 103 and then continuously taps 1221 or touches the touch screen 101 within a predetermined time, the control unit 201 may input the [symbol] or the [symbol] depending on the drag directions 1223 and 1225. For example, if the user performs the drag operation 1223 in a horizontal direction from the upper bezel part 103 and then continuously taps 1221 the touch screen 101 within a predetermined time, the control unit 201 may input the [symbol] . If the user performs the drag operation 1225 in a vertical direction from the left bezel part 103 and then continuously taps 1221 the touch screen 101 within a predetermined time, the control unit 201 may input the [symbol] .

Here, the drag operation may be an operation of moving the user's finger while the user's finger keeps the touch. The finger may be replaced by the stylus pen. Further, the drag operation may be replaced by the swipe or flick operation.

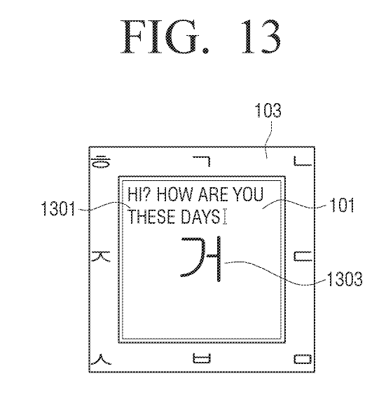

FIG. 13 is a diagram illustrating an example of inputting Hangeul according to an embodiment of the present disclosure. FIG. 13 illustrates the touch screen 101, the bezel part 103, all the input text lines 1301, and a character 1303 which is being currently input. The control unit 201 may receive Hangeul by combining the touch, tap or drag operation sensed by the bezel part 103 with the touch or tap operation sensed by the touch screen 101. Here, the drag operation may be an operation of moving the user's finger while the user's finger keeps the touch. The finger may be replaced by the stylus pen. Further, the drag operation may be replaced by the swipe or flick operation.

For example, if the user taps the bezel part 103, the control unit 201 may control the bezel part 103 to display the representative consonants on the bezel part 103. If the user touches the [symbol] of the representative consonants displayed on the bezel part 103 and then releases the touch, the control unit 201 may input the [symbol] to the electronic apparatus 100. In this state, if the user taps the touch screen 101 and then continuously performs the drag operation in a vertical direction from the bezel part 103, the control unit 210 may input [symbol] 1303. The character which is being input is displayed on the central portion of the touch screen 101 and if the input is completed, the character may be displayed on the position at which the cursor is present.

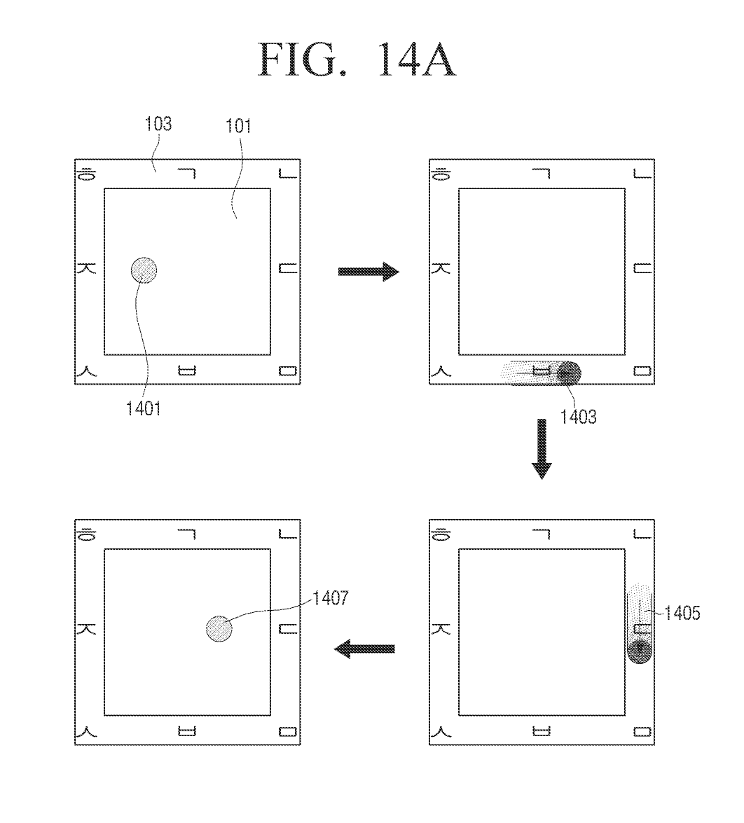

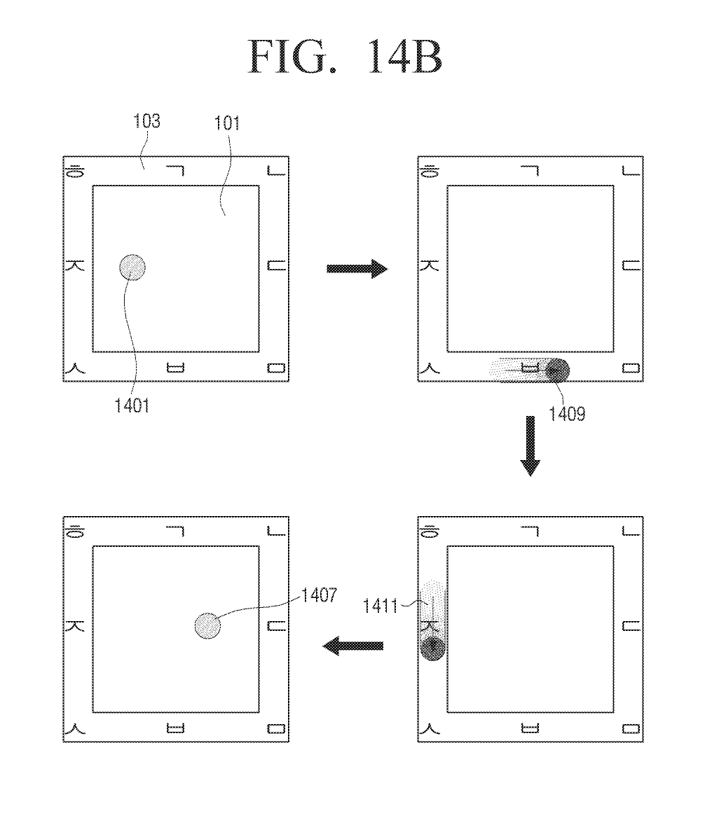

FIGS. 14A and 14B are diagrams illustrating an example of inputting Hangeul vowels according to an embodiment of the present disclosure. FIGS. 14A and 14B illustrate the touch screen 101 and the bezel part 103. The Hangeul vowel may be determined according to the user operation of touching the touch screen 101 and performing the drag operation at the bezel part 103. For example, if the user touches 1401 the touch screen 101, performs the drag operation at a lower portion 1403 and a right side 1405 of the bezel part 103 within a predetermined time, and again touches 1407 the touch screen 101, the control unit 201 may input a Hangeul vowel [symbol] . Alternately, if the user touches 1401 the touch screen 101, performs the drag operation at the lower portion 1409 and a left side 1411 of the bezel part 103 within a predetermined time, and again touches 1407 the touch screen 101, the control unit 201 may input the Hangeul vowel [symbol] .

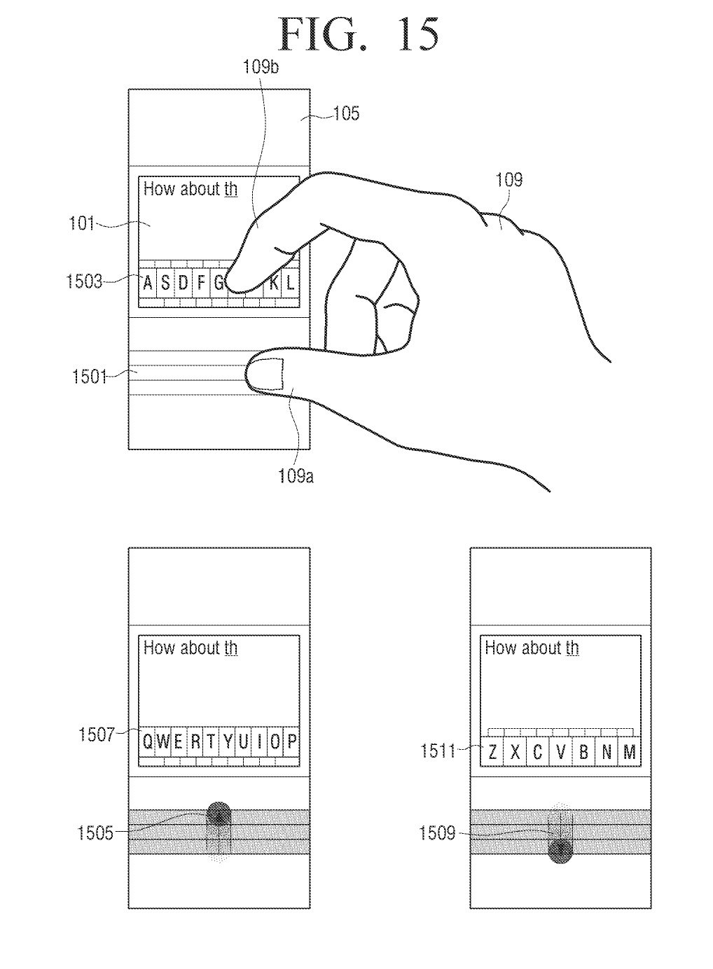

FIG. 15 is a diagram illustrating an example of inputting characters using a drag operation in a sensing unit 1501 included in a strap 105. Here, the drag operation may be replaced by the swipe or flick operation. FIG. 15 illustrates the touch screen 101, the bezel part 103, and the strap 105. The electronic apparatus 100 may include the touch screen 101 displaying a keyboard and sensing a user input; the bezel part 103 housing the touch screen 101; the strap 105 connected to the bezel part 103; the touch sensing unit 103a positioned at the strap 105 and sensing the user input in the strap 105; and the control unit 201 allowing the touch sensing unit 103a to receive the first user input, enlarging some of the keyboard displayed on the touch screen 101 and displaying the enlarged keyboard based on the first user input, receiving a second user input selecting one character from the enlarged keyboard, and inputting the selected character to the electronic apparatus based on the second user input.

The strap 105 may include the sensing unit 1501 which may sense the touch. A keyboard may be displayed on the touch screen 101. The keyboard may be a qwerty keyboard. The qwerty keyboard may include a first line, a second line, and a third line. The user may directly touch the keyboard displayed on the touch screen 101 to input characters. If the user touches the strap 105 with his/her finger in the state in which the keyboard is displayed on the touch screen 101, the control unit 201 may control the touch screen 101 to enlarge a second line of three lines of the keyboard and display the enlarged second line. If a user's hand 109 performs the drag operation in a vertical direction with his/her fingers 109a and 109b in the sensing unit 1501 of the strap 105, the control unit 201 may control the touch screen 101 to change the enlarged line according to the motion of the finger in a vertical direction and display the enlarged line.

For example, if the user performs a drag operation 1505 upwardly in the sensing unit 1501 of the strap 105 in the state in which a second line 1503 of the keyboard is displayed on the touch screen 101 while being enlarged, the control unit 201 may control the touch screen 101 to enlarge a first line 1507 of the keyboard and display the enlarged first line 1507. That is, the first line of the keyboard may be displayed while being enlarged. In this case, the second line and the third line may be displayed at an original size. Alternatively, the second line and the third line are covered with the first line and thus only some thereof may be displayed on the touch screen 101.

Alternatively, if the user performs a drag operation 1509 downwardly in the sensing unit 1501 of the strap 105 in the state in which the second line 1503 of the keyboard is displayed on the touch screen 101 while being enlarged, the control unit 201 may control the touch screen 101 to enlarge a third line 1511 and display the enlarged third line 1511. That is, the third line of the keyboard may be displayed while being enlarged. In this case, the first line and the second line may be displayed at an original size. Alternatively, the first line and the second line are covered with the third line and thus only some thereof may be displayed on the touch screen 101.

If the user touches one character in the enlarged displayed keyboard, the control unit 201 may input the touched character. The input characters may be displayed on the left upper area of the touch screen 101 or the position at which the cursor is present.

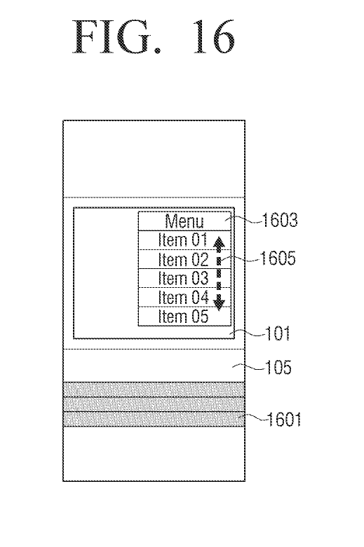

FIG. 16 is a diagram illustrating a method for scrolling an item of a menu screen according to the drag operation in a vertical direction from the sensing unit 1601 included in the strap 105. FIG. 16 illustrates the touch screen 101, the bezel part 103, and the strap 105. A menu 1603 of a plurality of items may be displayed on the touch screen 101. The control unit 201 may display the menu of the plurality of items on the touch screen 101, allow the touch sensing unit 103a to receive the third user input in the state in which the menu is displayed, and scroll the item based on the third user input. That is, if the user performs a drag operation in a sensing unit 1601 of the strap 105 in the state in which a menu 1603 is displayed on the touch screen 101, the control unit 201 may scroll 1605 the menu item in a vertical direction according to the drag operation. The third user input may be the drag operation.

For example, if the user performs the drag operation upwardly in the sensing unit 1601 of the strap in the state in which ‘item 01’ to ‘item 05’ are displayed on the menu 1603, the control unit 201 may scroll the menu item upwardly. If the user performs the drag operation downwardly in the sensing unit 1601 of the strap 105, the control unit 201 may scroll the menu item downwardly.

Further, if the user performs the drag operation in a vertical direction from the sensing unit 1601 of the strap 105 in the state in which one of the plurality of items is highlighted, the control unit 201 may control the touch screen 101 to change the highlighted item. For example, if the user performs the drag operation upwardly from the sensing unit 1601 of the strap 105 in the state in which the ‘item 03’ is highlighted, the control unit 201 may control the touch screen 101 to highlight the ‘item 02’. If the user performs the drag operation downwardly from the sensing unit 1601 of the strap 105 in the state in which the ‘item 03’ is highlighted, the control unit 201 may control the touch screen 101 to highlight the ‘item 04’.

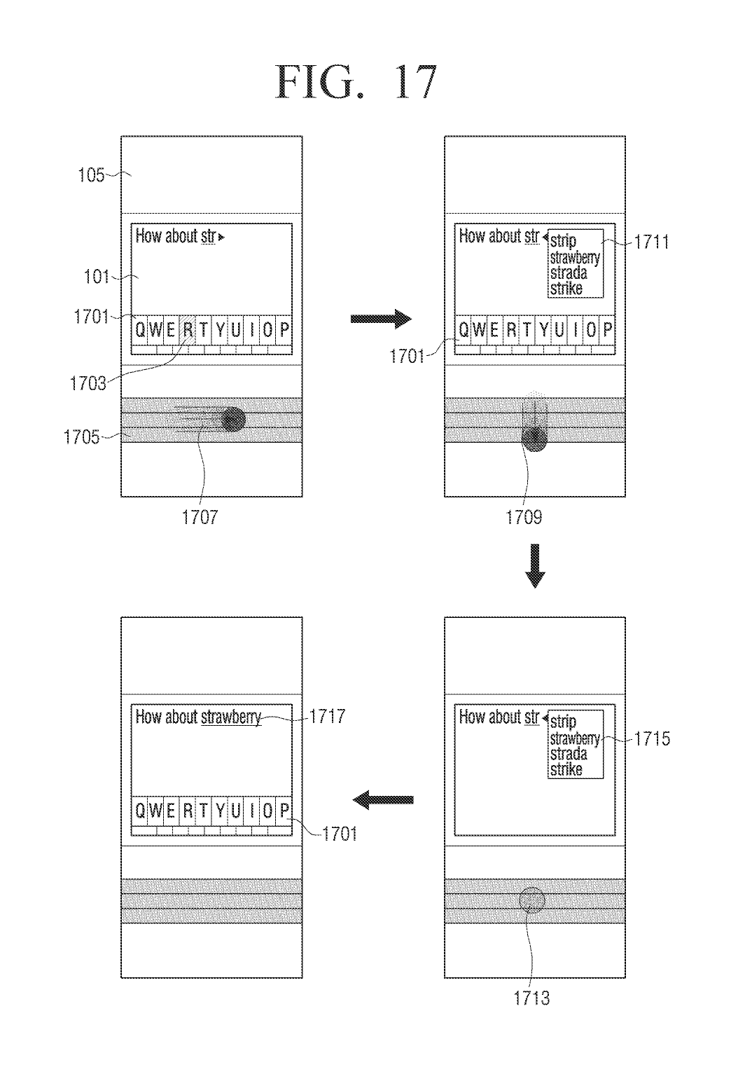

FIG. 17 is a diagram illustrating an example of inputting words according to the drag operation in the vertical and horizontal direction from the sensing unit 1705 included in the strap 105 and the touch input in the touch screen according to an embodiment of the present disclosure. FIG. 17 illustrates the touch screen 101, the bezel part 103, and the strap 105. Some 1701 of the keyboard may be enlarged to be displayed on the touch screen 101. When the keyboard is configured of three lines, one line may be displayed while being enlarged. For example, the first line of the keyboard may be displayed while being enlarged.

If the user touches one character 1703 in the enlarged displayed first line, the control unit 201 may control the touch screen 101 to display so as to visually distinguish different characters from the touched character 1703. That is, the touched character 1703 may be highlighted or may be displayed with changing its own color. In this state, if the user performs the drag operation in a right direction 1707 from the sensing unit 1705 of the strap 105, the control unit 201 may control the touch screen 101 to display a recommended word list 1711 starting from the touched word. In this case, the recommended word list 1711 may be displayed around the cursor. Further, one of a plurality of recommended words included in the recommended word list may be highlighted 1711. If the user performs the drag operation 1709 downwardly from the sensing unit 1705 of the strap 105 in the state in which the recommended word list is displayed, the control unit 201 may control the touch screen 101 to change the highlighted word 1715. That is, the highlighted recommended word may be changed according to the drag operation of the user. If the user taps 1713 the sensing unit 1705 of the strap 105, the control unit 201 may select the highlighted word and input the selected word 1717 to the electronic apparatus 100.

For example, when the recommended word list appears, ‘strip’ which is a word at a top portion may be displayed with being highlighted. In this state, if the user performs the drag operation downward from the sensing unit 1705 of the strap 105, the control unit 201 may control the touch screen 101 to display ‘strawberry’ with highlighting the ‘strawberry’ while the highlight moving downwardly. If the user touches the highlighted ‘strawberry’, the control unit 201 may input the word ‘strawberry’. Alternatively, if the user taps the sensing unit 1705 of the strap 105, the control unit 201 may input the word ‘strawberry’.

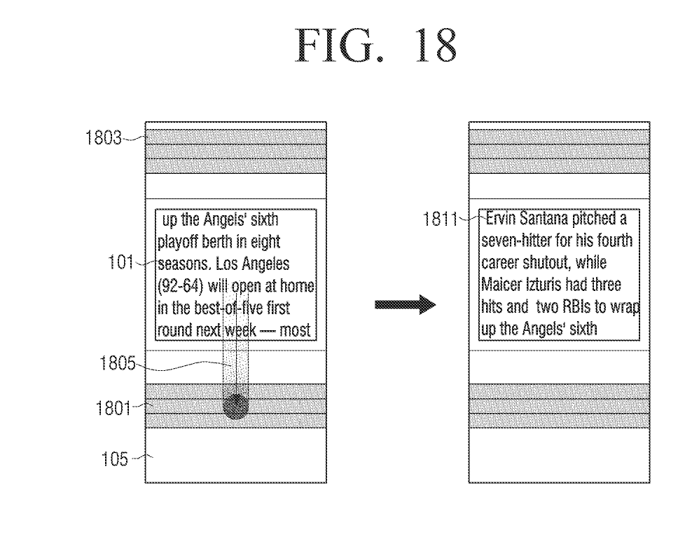

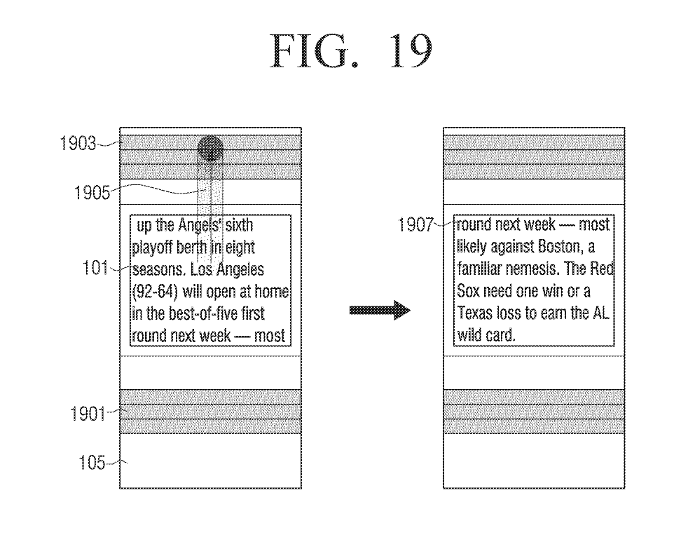

FIGS. 18 and 19 are diagrams illustrating a movement to a first portion and a final portion of a page displayed on the touch screen according to the drag operation toward the sensing unit in the touch screen 101 according to an embodiment of the present disclosure.

FIG. 18 illustrates the touch screen 101 and the strap 105. The strap 105 may include a plurality of sensing units 1801 and 1803. The strap 105 may include an upper sensing unit 1803 and a lower sensing unit 1801 based on the touch screen 101. Contents may be displayed on the touch screen 101. The contents may be an electronic book (E-book), a web page, and an electronic document which includes at least one page. A size of the page may be larger than that of the touch screen 101. If the user moves his/her finger up to the lower sensing unit 1801 while he/she touches the touch screen 101 with his/her finger in the state in which one page is displayed on the touch screen 101, the control unit 201 may control the touch screen 101 to display a first portion of the page on the touch screen 101. That is, if the user performs the drag operation 1805 starting from the touch screen 101 and ending at the lower sensing unit, the control unit 201 may control the touch screen 101 to display a first portion 1811 of the page on the touch screen 101. Here, the drag operation may be replaced by the swipe or flick operation.

On the contrary, if the user performs the drag operation from the touch screen 101 to the lower sensing unit 1801, the control unit 201 may control the touch screen 101 to display a final portion of the page on the touch screen 101.

FIG. 19 illustrates the touch screen 101 and the strap 105 according to an embodiment of the present disclosure. The strap 105 may include a plurality of sensing units 1901 and 1903. The strap 105 may include an upper sensing unit 1903 and a lower sensing unit 1901 based on the touch screen 101. Content may be displayed on the touch screen 101. The contents may be an E-book, a web page, and an electronic document which includes at least one page. A size of the page may be larger than that of the touch screen 101. If the user moves his/her finger up to the upper sensing unit 1903 while he/she touches the touch screen 101 with his/her finger in the state in which one page is displayed on the touch screen 101, the control unit 201 may control the touch screen 101 to display a final portion of the page 1907 on the touch screen 101. That is, if the user performs the drag operation 1905 starting from the touch screen 101 and ending at the upper sensing unit 1903, the control unit 201 may control the touch screen 101 to display a final portion of the page 1907 on the touch screen 101. Here, the drag operation may be replaced by the swipe or flick operation.

On the contrary, if the user performs the drag operation from the touch screen 101 to the upper sensing unit 1903, the first portion of the page may be displayed on the touch screen 101.

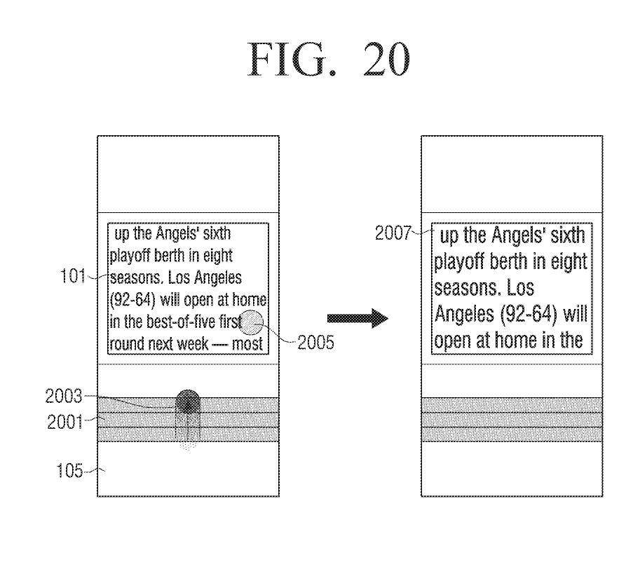

FIG. 20 is a diagram illustrating a process of enlarging or reducing a font of content displayed on the touch screen 101 according to the drag operation in a vertical direction from the sensing unit included in the strap 105 in the state in which the touch screen 101 is touched according to an embodiment of the present disclosure.

FIG. 20 illustrates the touch screen 101 and the strap 105. The strap 105 may include a sensing unit 2001. Contents may be displayed on the touch screen 101. The contents may be an E-book, a web page, and an electronic document which includes at least one page. A size of the page may be larger than that of the touch screen 101. When the content is displayed on the touch screen 101, if the user performs a drag operation 2003 in a vertical direction from the sensing unit 2001 in the state in which he/she touches 2005 the touch screen 101, the control unit 201 may control the touch screen 101 to enlarge 2007 or reduce a size of the font of the contents. For example, when the web page is displayed on the touch screen 101, if the user performs a drag operation 2003 upwardly from the sensing unit 2001 in the state in which he/she touches 2005 the touch screen 101, the control unit 201 may control the touch screen 101 to enlarge 2007 or reduce a size of the font of the contents. Further, when the web page is displayed on the touch screen 101, if the user performs a drag operation downwardly from the sensing unit 2001 in the state in which he/she touches 2005 the touch screen 101, the control unit 201 may control the touch screen 101 to reduce a size of the font of the contents.

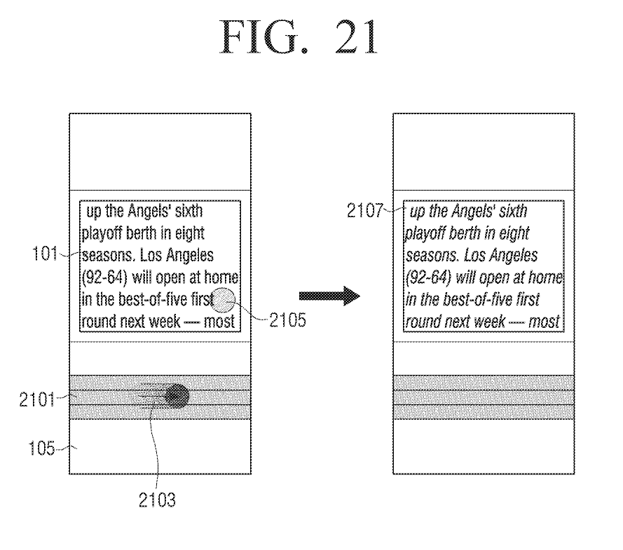

FIG. 21 is a diagram illustrating a process of changing a font displayed on the touch screen 101 according to the drag operation in a horizontal direction from the sensing unit included in the strap 105 in the state in which the touch screen 101 is touched according to an embodiment of the present disclosure.

FIG. 21 illustrates the touch screen 101 and the strap 105. The strap 105 may include a sensing unit 2101. Contents may be displayed on the touch screen 101. The contents may be an E-book, a web page, and an electronic document which includes at least one page. A size of the page may be larger than that of the touch screen 101. When the contents are displayed on the touch screen 101, if the user performs a drag operation 2103 in a right direction from the sensing unit 2101 in the state in which he/she touches 2105 the touch screen 101, the control unit 201 may control the touch screen 101 to change a font to other fonts 2107. In this state, if the user performs the drag operation in a left direction from the sensing unit 2101 in the state in which he/she touches 2105 the touch screen 101, the control unit 201 may control the touch screen 101 to change a font to an original font. For example, when content using a roman type font is displayed on the touch screen 101, if the user performs a drag operation in a right direction from the sensing unit 2101 in the state in which he/she touches 2105 the touch screen 101, the control unit 201 may control the touch screen 101 to change the font 2107 to an italic type font. In this state, if the user performs the drag operation in a left direction from the sensing unit 2101 in the state in which he/she touches 2105 the touch screen 101, the control unit 201 may control the touch screen 101 to change a font to the roman type font. That is, the font may be changed to an original font.

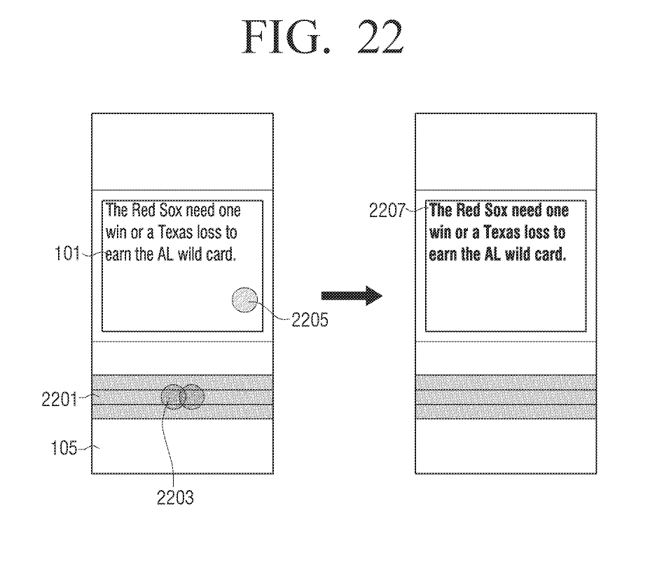

FIG. 22 is a diagram illustrating a process of changing font attributes of the content displayed on the touch screen 101 according to a tap operation in the sensing unit of the strap 105 in the state in which the touch screen 101 is touched according to an embodiment of the present disclosure.

FIG. 22 illustrates the touch screen 101 and the strap 105. The strap 105 may include a sensing unit 2201. Contents may be displayed on the touch screen 101. The contents may be an E-book, a web page, and an electronic document which includes at least one page. A size of the page may be larger than that of the touch screen 101. When the content is displayed on the touch screen 101, if the user taps 2203 the sensing unit 2201 in a state in which he/she touches 2205 the touch screen 101, the control unit 201 may control the touch screen 101 to change a font to a bold type font 2207. In this state, if the user taps the touch screen 101, the control unit 201 may control the touch screen 101 to change the font to an original font.

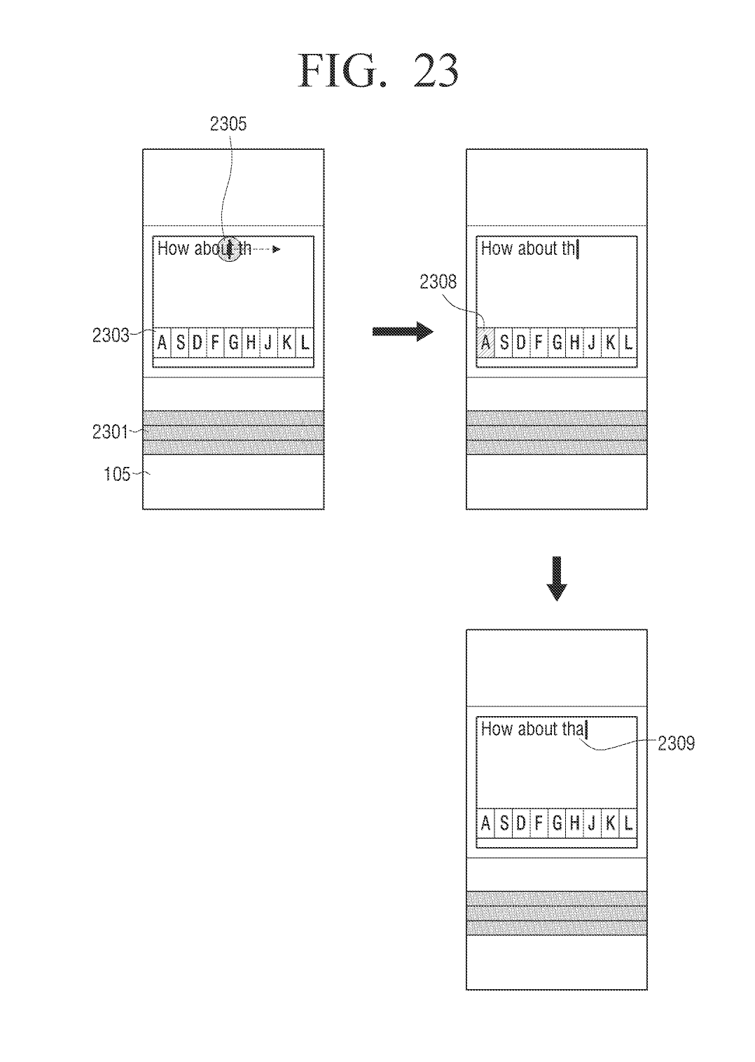

FIG. 23 is a diagram illustrating a method for inputting characters using the sensing unit installed at an end of the strap 105 according to an embodiment of the present disclosure. FIG. 23 illustrates the touch screen 101 and the strap 105. A sensing unit 2301 may be included in the end of the strap 105. When the user wears the electronic apparatus 100 on his/her wrist, the sensing unit may be positioned at an opposite side of the touch screen 101 and the user may feel as if he/she touches a rear portion of the touch screen 101.

Contents may be displayed on the touch screen 101. The contents may be an E-book, a web page, and an electronic document which includes at least one page. A size of the page may be larger than the touch screen 101. A screen for inputting characters may be displayed on the touch screen 101. In detail, a keyboard 2303 may be displayed on the touch screen 101. If the user touches the sensing unit 2301, the control unit 201 may control the touch screen 101 to display one character of the keyboard while highlighting 2308 the character and may control the touch screen 101 to change the highlighted character according to the touch motion of the user. That is, if the user moves his/her finger in the sensing unit 2301, the highlighted character 2308 may be changed. If the user moves his/her finger in the sensing unit 2301 to position 2305 a highlight on a character which he/she wants to input and releases the touch, the control unit 201 may select the highlighted character 2308 and input 2309 the selected character to the electronic apparatus 100. If the touch is released, the control unit 201 may control the touch screen 101 to let the highlight disappear. The highlight 2305 may be displayed to be more visually distinguished than the surroundings.

For example, if the user brings his/her finger into contact with the sensing unit, the control unit 201 may control the touch screen 101 to activate a focus on one character of the keyboard. In this case, a contact position of the user's finger is a sensing unit 2301 of the strap 105, but the user may feel as if he/she touches the rear portion of the touch screen 101.

The user moves his/her finger in the sensing unit 2301, such that the highlighted position may move. The user moves his/her finger to move a highlight to ‘A’, thereby inputting ‘A’ 2308. If the touch is released, the ‘A’ is input and the ‘A’ may be displayed 2309 on the touch screen 101.

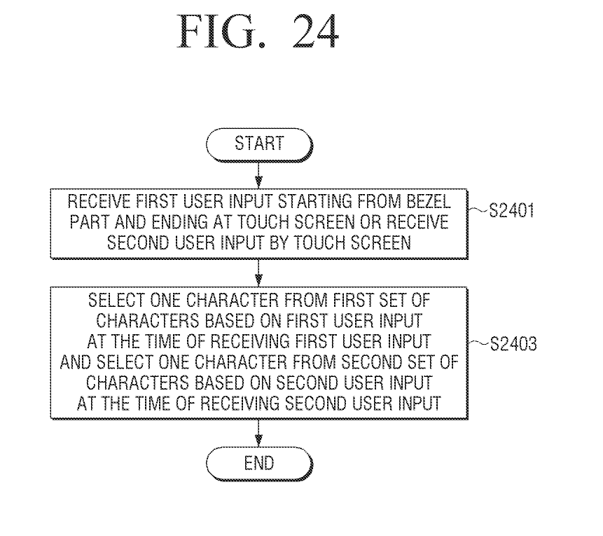

FIG. 24 is a flow chart illustrating a process when the bezel part 103 and the touch screen 101 receive the user input according to an embodiment of the present disclosure.

In operation S2401, the electronic apparatus 100 may receive the first user input starting from the bezel part 103 and ending at the touch screen 101 or receive the second user input from the touch screen 101 toward the bezel part 103. The bezel part 103 may include the touch sensing unit 103a and if the user touches the bezel part 103, the electronic apparatus 100 may determine a touched position and a kind of touch operation based on a signal output from the touch sensing unit 103a. The user may start a touch in the bezel part 103 and perform the drag operation toward the touch screen 101 while the touch is maintained and may perform the drag operation up to the touch screen 101 and then end the drag operation in the touch screen 101.

The first user input may be the drag operation of the user from the bezel part 103 toward the touch screen 101. A width of the bezel part 103 may be smaller than a size of the finger, and therefore the drag operation of the user may start from the bezel part 103 and end at the touch screen 101.

The second user input may be the drag operation of the user from the touch screen 101 toward the bezel part 103. When the bezel part 103 includes four sides, if the user performs the drag operation in the touch screen 101, the drag operation may be toward each side of the bezel part 103 or the corner portions of the bezel part 103.

In operation S2403, the electronic apparatus 100 may select one character from the first set of characters based on the first user input when the first user input is received and select one character from the second set of characters based on the second user input when the second user input is received.

The first set of characters may be a set of consonants. Alternatively, the first set of characters may be some of the consonants. When the first set of characters is some of the consonants, the first set of characters may be a set of representative consonants. Each of the representative consonants may have the corresponding lower consonants.

The second set of characters may be a set of vowels. The electronic apparatus 100 may determine one of the representative consonants when receiving the first user input. When receiving the first user input, the electronic apparatus 100 may select one character from the first set of characters depending on the length of the first user input. When the first user input is the drag operation, the electronic apparatus 100 may select one from the lower consonants corresponding to the representative consonants depending on the length of the drag operation. In this case, the electronic apparatus 100 may include temporarily displaying the selected character on the touch screen 101 and inputting the selected character to the electronic apparatus 100 when the first user input is released.

As the user performs the drag operation, the lower consonants may be displayed on the touch screen 101 and the lower consonants may be displayed while being changed as the drag operation is progressed. Further, if the drag operation is released, the characters displayed on the touch screen 101 may be input to the electronic apparatus.

The electronic apparatus 100 may determine characters to be input to the electronic apparatus 100 based on the position at which the first user input is sensed. The bezel part 103 may include four sides and four corners. The position at which the first user input is sensed may be any one of the four sides and the four corners of the bezel part 103. The characters may correspond to each side and each corner. If the bezel part 103 senses the touch, the electronic apparatus 100 determines whether the touch is sensed at any side of the four sides or whether the touch is sensed at any corner of the four corners and may determine characters corresponding thereto on the base of the determination.

The interaction method for the electronic apparatus 100 may include receiving, by one of the four sides of the bezel part 103, the third user input and selecting one character from the third set of characters based on the third user input. The third user input may be the drag operation sensed by the bezel part 103. That is, the third user input may be the drag operation proceeding in a length direction of the sides of the bezel part 103. The electronic apparatus 103 may select one character from the third set of characters depending on at which side the drag operation is sensed. The third set of characters may be a component configuring vowels.

Further, the interaction method for the electronic apparatus 100 may include receiving the first user input starting from the bezel part 103 and ending at the touch screen 101 and selecting one character from the first set of characters based on the position at which the first user input is sensed and the length of the first user input.

Further, the interaction method for the electronic apparatus 100 may further include receiving the second user input moving from the touch screen 101 toward the bezel part 103 and selecting one character from the second set of characters based on a direction of the movement.

Further, the interaction method for the electronic apparatus 100 may include receiving, by the touch sensing unit 103a, the first user input, enlarging some of a virtual keyboard displayed on the touch screen 101 and displaying the enlarged keyboard based on the first user input, receiving the second user input selecting one character from the enlarged keyboard, and inputting the selected character to the electronic apparatus 100 based on the second user input.

Further, the interaction method for the electronic apparatus 100 may further include displaying the menu including the plurality of items on the touch screen 101 and receiving, by the touch sensing unit 103a, the third user input in the state in which the menu is displayed and scrolling the menu item based on the third user input.

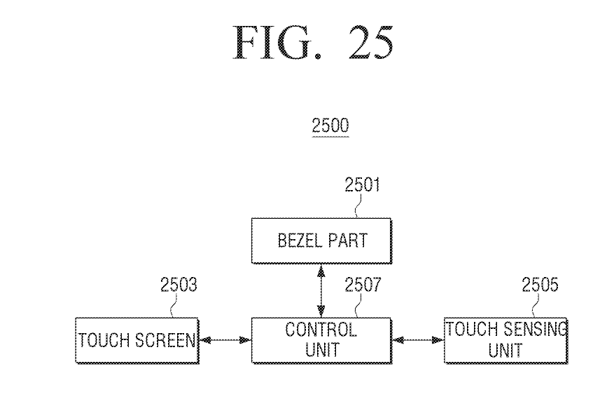

FIG. 25 is a block diagram schematically illustrating a configuration of an electronic apparatus 2500 according to another embodiment of the present disclosure. As illustrated in FIG. 25, the electronic apparatus 2500 may include a bezel part 2501, a touch screen 2503, a touch sensing unit 2505, and a control unit 2507.

The bezel part 2501 houses the touch screen 2503. In this case, when the touch screen 2503 is a square, the bezel part 2501 may include four sides.

The touch screen 2503 displays contents and senses the user input.

The touch sensing unit 2505 is positioned at the bezel part 2501 to sense the user input which is input to the bezel part 2501.

The control unit 2507 controls a general operation of the electronic apparatus 2500. In particular, when receiving the first user input starting from the bezel part 2501 and ending at the touch screen 2503, the control unit 2507 may select one character from the first set of characters based on the first user input. Further, when the touch screen 2503 receives the second user input, the control unit 2507 may select one character from the second set of characters based on the second user input. In this case, the control unit 2507 may select one character from the first set of characters depending on the length of the first user input. Further, the control unit 2507 may control the touch screen 2503 to temporarily display the selected character on the touch screen 2503. Further, when the user input is released, the control unit 2507 may input the character at the time when the user input is released to the electronic apparatus 2500. Further, the control unit 2507 may determine the characters to be input to the electronic apparatus 2500 based on the position at which the first user input is sensed. Further, when one of the four sides of the bezel part 2501 receives the third user input, the control unit 2507 selects one character from the third set of characters based on the third user input.

The user may more conveniently input characters even using a smaller screen by using the electronic apparatus 2500 as described above.

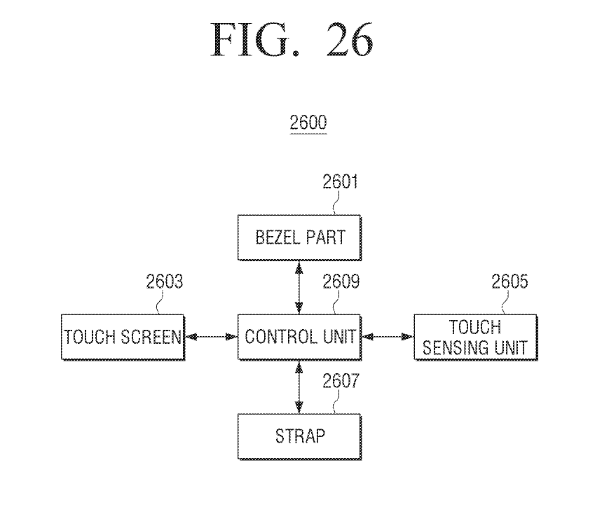

FIG. 26 is a block diagram schematically illustrating a configuration of an electronic apparatus 2600 according to another embodiment of the present disclosure. As illustrated in FIG. 26, the electronic apparatus 2600 may include a bezel part 2601, a touch screen 2603, a touch sensing unit 2605, a strap 2607, and a control unit 2609. Meanwhile, the bezel part 2601 and the touch screen 2603 described with reference to FIG. 26 are similar to the bezel part 2501 and the touch screen 2503 described with reference to FIG. 25 and therefore the detailed description thereof will be omitted.

The touch sensing unit 2605 is positioned at the strap 2607 to sense the user input for the strap 2607.

The strap 2607 may be connected to the bezel part in a band form and may fix the electronic apparatus 2600 to a user's wrist.

The control unit 2609 controls the general components of the electronic apparatus 2600. In particular, when the touch sensing unit 2605 receives the first user input, the control unit 2609 may control the touch screen 2603 to enlarge some of the keyboard displayed on the touch screen 2603 and display the enlarged keyboard based on the first user input. Further, when receiving the second user input selecting one character from the enlarged keyboard, the control unit 2609 may input the selected character to the electronic apparatus 2600 based on the second user input. Further, when the touch sensing unit 2605 receives the third user input while the menu including the plurality of items is displayed on the touch screen, the control unit 2609 may scroll the item based on the third user input.

As described above, the user may more conveniently control the electronic apparatus 2600 by receiving the user input using the touch sensing unit 2605 positioned at the strap 2607.

According to various embodiments of the present disclosure, it is possible to provide the convenient interaction method for an electronic apparatus to a user.

The electronic apparatus according to the various embodiments of the present disclosure may include a processor, a memory storing and executing program data, a permanent storage (e.g., storage unit 203) such as a disk drive, a communication port communicating with external devices, a touch panel, a key, a UI device such as a button, etc. Methods implemented by a software module or algorithm may be stored on a computer-readable recording medium as computer-readable codes or program commands which are executable by the processor. Here, as the computer-readable recording medium, there are a magnetic storage medium (for example, ROM, RAM, floppy disc, hard disc, etc.) and an optical reading medium (for example, compact disc ROM (CD-ROM), digital versatile disc (DVD)), etc. Further, the computer-readable recording medium is distributed into computer systems connected to a network and also includes a form in which the computer-readable code is stored and executed based on a distribution type. The medium may be read by a computer, stored in the memory, executed by the processor.

The embodiment of the present disclosure may be represented by functional block configurations and various processing steps. The functional blocks may be implemented by various number of hardware or/and software configurations which execute specific functions. For example, the embodiment of the present disclosure may adopt direct circuit configurations such as memory, processing, logic, and look-up table which may execute various functions by a control of at least one microprocessor or other control devices. Like executing the components by software programming or software elements, the present embodiment includes various algorithms which are implemented by a data structure, processes, routines, or a combination of other programming configurations, which may be implemented programming or scripting languages such as C, C++, Java, and assembler. The functional aspects may be implemented by algorithm which is executed by at least one processor. Further, the present embodiment may adopt the related art for electronic environmental setting, signal processing, and/or data processing, etc. The terms “mechanism”, “element”, “means”, “configuration”, etc., may be widely used and are not limited to mechanical and physical components. The terms may include a meaning of a series of routines of software in connection with the processor, etc.

Specific executions described in the present embodiment are examples and therefore do not limit the technical ranges of the present disclosure. For simplification of the present specification, the description of the typical electronic components, control systems, software, or other functional aspects of the systems may be omitted. Further, connections or connection members of lines between components illustrated in the drawings exemplarily illustrate the functional connections and/or the physical or circuited connections and in the actual device, may be replaced or may be represented as additional various functional connections, the physical connections, or the circuit connections.

The use of the term “the” and the indication term similar thereto in the present specification (in particular, claims) may correspond to a singular form and a plural form. Further, the description of the range includes individual values belonging to the range (unless stated specifically), which is that each individual value configuring the range is described in the detailed description. Finally, an order for steps configuring the method is clearly described or unless stated specifically, the steps may be performed in a proper order. The present embodiment is not necessarily limited to the description order of the steps. The use of all examples or exemplified terms (for example, and so on) is to describe in detail the technical spirit and therefore the scope of the present disclosure is not limited to the examples or the exemplified terms as long as it is not limited by claims. Further, those skilled in the art may be appreciated that various modifications, combinations, and changes may be configured depending on design conditions and factors within added claims or the scope of equivalents thereof.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a touch screen configured to display contents and to sense a user input that is input to the touch screen;
a bezel part housing the touch screen;
a touch sensing unit configured to sense a user input that is input to the bezel part; and
a control unit configured to:
select one character from a first set of characters based on a first user input when receiving the first user input starting at the bezel part and ending at the touch screen, and
select one character from a second set of characters based on a second user input when the touch screen receives the second user input.

2. The electronic apparatus of claim 1, wherein the control unit is configured to select the one character from the first set of characters depending on a length of the first user input when receiving the first user input.

3. The electronic apparatus of claim 1, wherein the control unit is configured to:
temporarily display the selected one character on the touch screen, and
input the one character to the electronic apparatus when the first user input is released.

4. The electronic apparatus of claim 1, wherein the control unit is configured to determine the one character to be input to the electronic apparatus based on a position at which the first user input is sensed.

5. The electronic apparatus of claim 1, wherein the bezel part includes a plurality of sides, and
wherein the control unit is configured to:
receive a third user input from one of the plurality of sides, and
select one character from a third set of characters based on the third user input.

6. The electronic apparatus of claim 1, wherein the control unit is configured to select one character from the second set of characters based on a direction of the second user input.

7. An electronic apparatus comprising:
a touch screen configured to display contents and to sense a user input that is input to the touch screen;
a bezel part housing the touch screen;
a touch sensing unit configured to sense the user input that is input to the bezel part; and
a control unit configured to:
receive a first user input starting at the bezel part and ending at the touch screen, and
select one character from a first set of characters based on a position at which the first user input is sensed and a length of the first user input.

8. The electronic apparatus of claim 7, wherein the control unit is configured to:
receive a second user input from the touch screen toward the bezel part, and
select one character from a second set of characters based on a direction of the second user input.

9. An electronic apparatus comprising:
a touch screen configured to display a keyboard and to sense a user input that is input to the touch screen;
a bezel part housing the touch screen;
a strap connected to the bezel part;
a touch sensing unit positioned at the strap and configured to sense a user input that is input to the strap; and
a control unit configured to:
allow the touch sensing unit to receive a first user input,
enlarge some of the keyboard displayed on the touch screen,
display the enlarged keyboard based on the first user input,
receive a second user input selecting one character from the enlarged keyboard, and
input the selected character to the electronic apparatus based on the second user input.

10. The electronic apparatus of claim 9, wherein the control unit is configured to:
display a menu including a plurality of items on the touch screen,
allow the touch sensing unit to receive a third user input in a state in which the menu is displayed, and
scroll the item based on the third user input.

11. An interaction method for an electronic apparatus, the interaction method comprising:
receiving a first user input starting at a bezel part and ending at a touch screen or receiving, by a touch screen, a second user input; and
selecting one character from a first set of characters based on a first user input when the first user input is received and selecting one character from a second set of characters based on a second user input when the second user input is received.

12. The interaction method of claim 11, wherein in the selecting, when the first user input is received, the one character is selected from the first set of characters depending on a length of the first user input.

13. The interaction method of claim 12, further comprising:
temporarily displaying the selected one character on the touch screen; and
when the first user input is released, inputting the selected one character to the electronic apparatus.

14. The interaction method of claim 11, wherein in the selecting, the one character to be input to the electronic apparatus is determined based on a position at which the first user input is sensed.

15. The interaction method of claim 11, further comprising:
receiving a third user input from one of a plurality of sides; and
selecting one character from a third set of characters based on the third user input.
wherein the bezel part includes the plurality of sides.

16. The interaction method of claim 11, wherein in the receiving of the second user input, one character is selected from the second set of characters based on a direction of the second user input.

17. An interaction method for an electronic apparatus, the interaction method comprising:
receiving a first user input starting at a bezel part and ending at a touch screen; and
selecting one character from a first set of characters based on a position at which the first user input is sensed and a length of the first user input.

18. The interaction method of claim 17, further comprising:
receiving a second user input moving from the touch screen toward the bezel; and
selecting one character from a second set of characters based on a direction of the second user input.

19. An interaction method for an electronic apparatus, the interaction method comprising:
receiving, by a touch sensing unit, a first user input;
enlarging some of a virtual keyboard displayed on a touch screen based on the first user input;
displaying the enlarged virtual keyboard;
receiving a second user input selecting one character from the enlarged keyboard; and
inputting the selected character to the electronic apparatus based on the second user input.

20. The interaction method of claim 19, further comprising:
displaying a menu including a plurality of items on the touch screen; and
receiving, by the touch sensing unit, a third user input in a state in which the menu is displayed and scrolling the menu item based on the third user input.
